(19) United States
(12) Patent Application Publication
(10) Pub. No.: US 2006/0253894 A1
(43) Pub. Date: Nov. 9, 2006

(54) Mobility device platform

(76) Inventors: Peter Bookman, Draper, UT (US); Rick Charles White, Salt Lake City, UT (US); Michael Anderer, Salt Lake City, UT (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/326,008

(22) Filed: Jan. 5, 2006

Related U.S. Application Data
(63) Continuation-in-part of application No. 10/837,426, filed on Apr. 30, 2004.
(60) Provisional application No. 60/641,395, filed on Jan. 5, 2005.
(60) Provisional application No. 60/641,806, filed on Jan. 6, 2005.
(60) Provisional application No. 60/671,611, filed on Apr. 15, 2005.
(60) Provisional application No. 60/738,493, filed on Nov. 21, 2005.

(51) Int. Cl. H04L 9/32

(52) U.S. Cl. 726/2; 455/414.2

(57) ABSTRACT

A mobility device platform allowing for secure mobile computing is provided. In an illustrative implementation, an exemplary mobility device platform comprises a mobility device operable to communicate with at least one host environment through one or more communications interfaces. The mobility device is further operable to process and store data. The plafrom can further comprise, a communications network operable to communicate data and the mobility originating from one or more cooperating components and a mobility device management server operable to generate, process, store, communicate and encrypt data to the mobility device. Further, the mobility device management server ca be operable to perform one or more mobility device provisioning, administration, and management functions and to authenticate and verify cooperating mobility devices according to a seleted trust model. In the illustrative implementation, the mobility device can operte with various host environmnets using various communications protocols and paradigms.

### CLAIM OF PRIORITY AND CROSS REFERENCE

This application is Continuation-In-Part of U.S. patent application Ser. No. 10/837,426, filed Apr. 30, 2004, entitled, “MOBILITY DEVICE PLATFORM”, and claims all appropriate priority to such application. Additionally, this application claims the benefit of and herein incorporates by reference, in their entirety, the following U.S. Provisional Patent Applications: 60/641,395, filed Jan. 5, 2005, entitled, “MOBILITY DEVICE SECURITY SYSTEM”, 60/641,806, filed Jan. 6, 2005, entitled “MOBILITY DEVICE SYSTEM”, 60/671,611, filed Apr. 15, 2005, entitled “MOBILITY DEVICE SYSTEM II”, 60/771,013, filed Aug. 24, 2005, entitled “MOBILITY DEVICE SYSTEM III”, 60/738,493 filed Nov. 21, 2005, entitled “MOBILITY DEVICE SYSTEM IV”. Additionally, this application is related to, cross-references, and herein, incorporates by reference in its entirety the following co-pending applications: Ser. No. ______, entitled, “MOBILITY DEVICE,” (Attorney Docket: 45597/211107) and Ser. No. ______, entitled, “MOBILITY DEVICE PLATFORM PARADIGM,” (Attorney Docket: 45597/211109).

### TECHNOLOGY FIELD

The herein described systems and methods relate to mobile computing technologies, and more importantly, to a mobility device platform.

### BACKGROUND

Enterprises and individuals, alike, increasingly require mobility as a feature of their computing environment(s). For enterprises, mobility allows the deployment of personnel across disparate geographic locations allowing the enterprises to better serve their clients. For example, a large pharmaceutical corporation may wish to deploy their sales personnel in the “field” close to prospective customers (e.g. doctors). In such context, “field” personnel may wish to have access to sensitive sales and marketing information and computing application over a secure connection. With current solutions, these personnel are often left with the cumbersome task of “synchronizing” their data at the end of the day with their corporate network through some secure computer network connection (e.g. virtual private network). Comparatively, individuals seek mobility in their computing environments to allow for the ability to be close to their data and computing applications, and more importantly, to continually stay “connected” in the age of Internet communications.

Responsive to the need for mobile computing, computing environment manufacturers have developed mobile computing technologies (e.g. stand alone, networked, and/or embedded) that allow people to enjoy their computing environments on the road. Such mobile devices aim at allowing the user to “carry” their files and applications with them at all times. Although providing mobility, these devices tend to be marginally effective as they vary in form factor, processing capability, and portability. With such limitations, users are often relegated to lugging around large portable computers to ensure that they have all of their needed files and computing applications. Such practice is premised on the inherent deign of computing systems—namely employing “device-centric” computing.

With “device-centric” computing users, although may have access to files remotely and securely via remote communications applications (e.g. virtual private networks), still are relegated to carry around large cumbersome computing instrumentalities to retrieve their data and computing applications. More importantly, with device centric computing, users are generally provisioned one device for their enterprise computing needs (e.g. company personal computer, or laptop) and generally have one or more computing environments in their home for personal use. In maintaining multiple computing environments, computer users are charged with the task of synchronizing their custom preferences and settings among their many different computing environments. Such task is arduous at best and often leaves computer users frustrated in not having access to desired data and/or computing applications between their many different computing environments.

For example, a computer user may wish to have their financial planning and management data from his/her financial planning and management computing application (e.g. Quicken, Microsoft Money) with them at all times to address any payments that might spring up (e.g. a lapsed bill). With current solutions, the computing user is relegated to install the financial planning and management computing application and data on each of his/her computing environments (including his/her corporate computer—which may be in violation of corporate computing policies and procedures) so that he/she can have access to this desired data. Comparatively, enterprises may wish to effectively and immediately terminate all access to sensitive corporate data from employees who are to be terminated. Under current practices that are based on device-centric computing, the employee is asked to turn in their computing environments (e.g. laptops, personal computers, mobile phone, or personal digital assistants). Additionally, the soon-to-be terminated employee may be restricted in their use of corporate data by terminating their enterprise user directory information. However, there is an inherent latency in collecting such devices and terminating access. Such latency could result in the employee copying files from the enterprise computing environment for their subsequent use. As such, under existing practices sensitive enterprise data may be compromised.

Apart from the enterprise environment, mobile computing capabilities are being required more often by end-users generally. In a greater context, mobile computing affords a seamless experience for the end user as the end-user is afforded the ability to “carry” desired data and applications (or alternatively carry a means by which they can access desired data and applications) from one computing environment to another. Current practices allow users access to specific data and/or applications through a mobile computing means, however, often relegating the configuration of a “seamless” experience to the end-user. Stated differently, the end-user is charged with the tedious, time-consuming, and arduous tasks of synchronizing data and/or applications from a host computing environment (e.g., home computer, work computer, etc.) to their mobile computing device (e.g., mobile PDA, mobile phone, etc.). With some current solutions, users can directly access data/applications stored on a cooperating server with their mobile device.

However, with current mobile computing practices, the user's experience is significantly limited by the form factor of the mobile device. In essence, the end-user is offered two user experiences—the experience encountered when interfacing with a conventional computing environment and the experience encountered when interfacing with the mobile device (e.g., small display screen, modified user peripherals, etc.). Outside of working on a portable personal computer (e.g., laptop computer), a user's experience is different with current mobile computing practices. Additionally, current mobile computing practices do not afford the user the ability to “carry” their personal computing environment preferences, user rights, privileges, authorizations, and authentication data. Stated differently, with current mobile computing practices, an end-user, often, is relegated to having two different custom settings/preferences for their mobile computing environment and their non-mobile computing environment. As a result an end-user is not offered a complete seamless transition as the end-user switches between a mobile and non-mobile computing environment. By not having persistent customization, an end-user is often relegated to customizing the various computing environments manually and, moreover, having to manually re-authenticate themselves when interfacing with cooperating server computing environments. Moreover, with current mobile computing practices, the inability to carry custom settings/preferences forecloses an end-users ability to interface with disparate computing environments (e.g., enterprise computing environment, personal home computing environment, automotive computing environment, consumer electronic computing environment, media sharing computing environment, etc) without relegating manual customization, configuration, authentication, and verification by the end-user with each of the disparate computing environments.

Furthermore, current mobile computing practices do not consider a mobile computing device operating on a municipal broadband data grid such that the mobile computing device is capable of communicating voice and data at broadband speeds and has the ability to cooperate with a plurality of communications networks employing disparate and incompatible wireless communication protocols/paradigms.

From the foregoing it is appreciated that there exists a need to overcome the shortcomings of existing practices.

### SUMMARY

A mobility device platform allowing for mobile computing is provided. In an illustrative implementation, an exemplary mobility device platform comprises a mobility device operable to communicate with at least one host environment through a selected communications interface, a communications network operable to communicate data and computing applications, and a mobility device management server operable to generate, process, store, communicate and encrypt data and/or applications to the mobility device. Further, the mobility device management server can be operable to perform one or more mobility device management functions for a cooperating mobility device.

In an illustrative operation, the exemplary mobility device can be configured for use on a cooperating host environment according to a selected trust model. In the illustrative operation, the selected trust model can instruct the mobility device to cooperate with the host environment to communicate custom settings/preferences (e.g., persona) to the host environment (e.g., presentation of an aura). In the illustrative operation, the mobility device can cooperate with the host environment to control one or more processing and memory functions of the host environment. Additionally, in the illustrative operation, the mobility device can cooperate with the host environment to have access to one or more input peripherals of the host environment as well as host environment power sources.

Further the mobility device can establish communications with cooperating one or more mobility device management servers using a selected trust model. In the illustrative operation, the mobility device management server can communicate data and/or applications (including custom settings, custom preferences, and content licenses (e.g., digital management rights)) to cooperating mobility device according to one or more instructions provided by the selected trust model. In an illustrative implementation, the selected trust model can comprise instructions for the mobility device management server to perform one or more functions for a cooperating mobility device including but not limited to authentication, encryption, verification, provisioning, administration, content licensing/rights management, and monitoring.

Other features of the herein described systems and methods are further described below.

### BRIEF DESCRIPTION OF THE DRAWINGS

The mobility device platform and methods of use are further described with reference to the accompanying drawings in which:

FIG. 1 is a block diagram of an exemplary computing environment in accordance with an implementation of the herein described systems and methods;

FIG. 2 is a block diagram of an exemplary computing network environment in accordance with the herein described system and methods;

FIG. 3 is a block diagram showing an illustrative interaction between exemplary computing components in accordance with the herein described systems and methods;

FIG. 4 is a block diagram of an illustrative implementation of a mobility device platform in accordance with the herein described systems and methods;

FIG. 5 is a block diagram of another illustrative implementation of a mobility device platform in accordance with the herein described systems and methods;

FIG. 6 is a block diagram showing the deployment of a trust model between a mobility device and a host environment in accordance with the herein described systems and methods;

FIG. 7 is a block diagram showing the interaction of exemplary components when presenting a stored persona as an aura on a cooperating host environment in accordance with the herein described systems and methods;

FIG. 8 is a block diagram showing the deployment of a mobile desktop environment in accordance with the herein described systems and methods;

FIG. 9 is a flow diagram of processing performed to configure an illustrative implementation of a mobility device platform in accordance with the herein described systems and methods;

FIG. 10 is a flow diagram of processing performed by an illustrative implementation of a mobility device platform in accordance with the herein described systems and methods;

FIG. 11 is a flow diagram of processing performed by another illustrative implementation of a mobility device platform in accordance with the herein described systems and methods;

FIG. 12 is a flow diagram of processing performed by another illustrative implementation of a mobility device platform in accordance with the herein described systems and methods;

FIG. 13 is a flow diagram of processing performed by an illustrative implementation of a mobility device platform when employing a selected trust model in accordance with the herein described systems and methods; and

FIG. 14 is a flow diagram of processing performed by an illustrative implementation of a mobility device platform when presenting a persona as an aura in accordance with the herein described systems and methods; and

FIG. 15 is a block diagram showing the deployment of a mobility device on a municipal broadband data grid in accordance with the herein described systems and methods.

### DETAILED DESCRIPTION

Overview:

The herein described systems and methods offer a “user-centric” approach to computing and mobile computing. Current computing solutions, enterprise or individual, are generally designed using a “device-centric” model. The device-centric model aims at managing and tracking users based on device assignments and designations. Current “device-centric” computing practices are cumbersome and offer limited capabilities. Specifically, with current “device-centric” practices, participating users are charged to managing their digital content rights (digital rights management (DRM) licenses), user authorizations (e.g., online passwords and user ids), user privileges (e.g., access to enterprise data), and user custom preferences (e.g., web browser bookmarks, the dim level of a room in the user's house controlled by a home automation system, the position of a steering wheel and/or driver's seat in a user's car that is controlled by an electronic automotive control system) as they switch from one cooperating electronic environment to another. For example, a participating user is currently charged with customizing each cooperating electronic environment that the participating user controls. Furthermore, since with current practices, the participating user is not offered a centralized customization capability so that the custom preferences, user rights, user privileges, and user authentications can be accessed and deployed in the cooperating electronic environment. Such inability results in a lack of optimization of the available features and operations of the cooperating electronic environments. For example, with current practices, a participating user is relegated to customize their work computer with their preferences, rights, authentications, and privileges and have to do the same with their home computer, their personal digital assistant, their mobile telephone, their home automation system, their automotive automation system, etc.

In the context of enterprise computing, the enterprise computing environment may comprise a number of server computing environments and numerous client computing environments. Generally, each user in the enterprise is provisioned client computing environment (e.g. personal computer or laptop computer) that is generally networked to the server computing environment through the enterprise communications interface or, if the user is remote to the enterprise communications network, through a virtual private network (VPN). Additionally, in conventional enterprise computing environments, the users are provided user identification information and password information through a directory services structure that associates user rights and privileges to certain enterprise data and computing applications.

With such enterprise computing environments, the user is often relegated to be only allowed to customize his/her provisioned computing environment with their preferences and settings such that if the user roams across the network and logs onto to a computing environment other than their own, they do not have access to their custom preferences and settings. This problem is also seen as enterprise users wishing to maintain synchronization in preferences and settings (e.g. browser bookmarks, look and feel of desktop, color scheme, layout of applications, and directory structure for files) between their enterprise computing environment and their personal computing environment (e.g. home computer) are often relegated to perform manual synchronization.

Moreover, with existing enterprise computing environments administration of the numerous client computing environments becomes a daunting task. Currently, enterprises hire information technology departments numbering in the tens, in not hundreds, to support the many users and their computing environments. Beyond mere physical administration, integrity and security of corporate data is put into play with the device-centric computing model. In such context, enterprise computing users are often left to their own volition in copying and comprising sensitive enterprise data. As the task of preventing users from unauthorized copying of enterprise files and data is daunting at best, most enterprises turn a blind eye. Such limitation of existing practices can be very costly to enterprises and individuals alike.

Additionally, current “device centric” practices do not allow participating users to easily carry and execute user digital rights, user privileges, user authorizations, and user custom preferences on various cooperating electronic environments. Rather current practices are generally limited to allowing users to transfer and deploy certain of user digital rights, user privileges, user authorizations, and user custom preferences on cooperating computing environments (e.g., personal computers, laptop computers, personal digital assistants, and mobile phones) not general cooperating electronic host environments. With current practices, participating users are not afforded the ability to “carry” such digital content rights, user privileges, user authorizations, and user custom preferences for execution on traditional non-computing host electronic environments (e.g., consumer/enterprise electronics and devices—digital video recorders (DVRs), voice over IP (VoIP) telephones; automotive electronic environment—automotive navigation system, automotive electronic car seats; home automation environment—home security system).

The herein described systems and methods aim to ameliorate the shortcomings of existing practices by providing a mobility device platform (MDP) designed using a “user-centric” model. In an illustrative implementation, the mobility device platform comprises at least one mobility device (MD) operable to communicate with one or more cooperating computing environments (e.g. personal computer, personal digital assistant, mobile phone, VoIP phone, car automation system, digital video recorder, cooperating consumer electronics, cooperating industrial electronics, networked computer, and other computer and non-computer based computing environments) through a communications interface (e.g. universal serial bus (USB), IEEE 1394 communications interface (Firewire), 802.XX communications interface (including but not limited to 802.16 and 802.11n), blutetooth communications interface, personal computer interface, small computer serial interface, and wireless application protocol (WAP) communications interface, powered Ethernet, GSM, CDMA, TDMA, RF). Additionally, the mobility device platform can comprise one or more mobility device management servers (MDMS) that operate to authenticate and verify and provide user and device management/administration for cooperating mobility devices and their users. Additionally, the mobility device management servers can operate to provide data and applications to the mobility device.

In operation, the mobility device may cooperate with one or more computing environments invoking one or more work spaces to process data. The data may be executed from computing applications local to the MD, or the MD may cooperate with one or more MDMS to obtain the desired data. The MDMS can operate to authenticate requesting MDs to ensure that they have the rights and privileges to the requested data and to verify the persona of the MD. Additionally, the MDMS can cooperate with third party data providers to obtain requested data. In such context, the MDMS can act to translate the data from a non-MD native data format to a native MD data. When communicating data from the MDMS to cooperating MDs, the MDMS and MD can engage in 1028 bit and/or 2056 bit encryption (e.g. PKI encryption) using user and device authentication and verification information. Additionally, the MD can operate to store the participating user's customized settings and preferences local to the MD so they are available to the user at all times. Further, the MD and MDMS can execute a selected trust model (e.g., bi-lateral trust arbitration) as part of the device/user authentication/verification and data encryption processes. Additionally, the selected trust model can be deployed by the MD on the cooperating electronic host environment to project a persona (e.g., customized settings, privileges, rights, and authentications) to the cooperating electronic host environment to generate an aura (e.g., a projected persona).

As such with the mobility device platform users can traverse any number of cooperating disparate computing environments confident that they will have access to their customized settings/preferences, authentications, privileges, and rights and, more importantly, secure access to desired data and applications (e.g., executable files).

As described, in an illustrative implementation, the mobility device platform can allow for trust-enabled mobile computing. In the illustrative implementation, the selected trust model can comprise encryption keys to allow for the encrypted communication of data between a cooperating mobility device management server and cooperating mobility devices, an authentication protocol that provides instructions for the authentication of cooperating mobility devices, and a verification protocol that provides instructions for the verification of cooperating mobility devices requesting data from the mobility device management server. The selected trust model can comprise a plurality of modalities for authentication and verification of cooperating mobility devices such as biometric authentication/verification and fortified query authentication/verification. The trust model can also leverage custom settings known as personas to project an aura between the mobility device and a cooperating computing environment.

In an illustrative implementation, the exemplary mobility device can operate on its own power supply to support an independent (i.e., independent from the cooperating computing environment) personalized and portable computing and/or operations control environment. In another illustrative implementation, the exemplary mobility device can operate using power from a cooperating communications interface (e.g., powered Ethernet) to support an independent (i.e., independent from the cooperating computing environment) personalized and portable computing and/or operations control environment. In the illustrative implementation, the mobility device can operate according to a parasitic and/or redundant power protocol.

A parasitic power protocol can comprise a method in which the mobility device first draws power from the cooperating computing environment and, in the instance that power supply becomes unavailable, being able to draw power from a power sources found on the mobility device. Further a parasitic power protocol can include the following instructions: 1) powering the mobility device, 2) charging the mobility device, 3) powering the mobility device, 4) powering the mobility device while also charging an energy store on the mobility device, 3) powering the mobility device while also discharging (drawing from) an exemplary energy store. Some power sources for the mobility device can include but are not limited to, 1) power charger (direct), 2) power-over-Ethernet, 3) power-over-USB, 4) power-over-FireWire, 5) power-over-PCI-express, 6) any serial or parallel physical input/output channel, and 7) any serial or parallel wireless input/output channel (e.g., RFID, GPRS). Some power storage devices can include one or more of following, 1) battery, 2) fuel cell, 3) capacitor, and 4) fly wheel.

Further in an illustrative operation, an exemplary parasitic power protocol can comprise the instruction which can be executed by the mobility device to overdraw(discharge) from multiple power sources or stores when performance demands require it, and under-draw/charge from one or two sources to one or more stores when performance demands allow it.

A redundant power protocol can comprise having more than one power source for the mobility device such that operation is not comprised if one of the more than one power supplies fails. The key elements we need to cover for parasitic power:

In another illustrative operation, the mobility device can present itself to the cooperating computing environment as one of peripheral devices including but not limited to any peripheral device operating on various interface ports (e.g., IEEE spec ports, video port, peripheral ports, display ports, etc.). In the illustrative operation, the mobility device can also present itself to the cooperating computing environment as an external flash storage drive with the appearance of containing two files, e.g., “in” file and “out” files. In the illustrative operation, an exemplary network routing process operating on the mobility device can drop (and pick up) data communication frames (e.g., Ethernet frames) to/from the flash resident “in” and “out” files. In an illustrative implementation, the presented flash resident files can operate to stream block input/output interfaces to processes running on the exemplary mobility device.

In the illustrative implementation, by presenting the mobility device to the cooperating computing environment as a flash storage device having the i/o files, various benefits can be realized including but not limited to: 1) firewall protection incompatibilities of the cooperating computing environment are not triggered, 2) data communication (e.g., TCP) formatting is performed by the host which can improve performance on the cooperating computing environment, and 3) better compatibility between the mobility device and the cooperating computing environment.

In another illustrative operation, the mobility device can operate in a manner to process, store, and retrieve forensic evidence. In an illustrative implementation, forensic evidence can be stored in a secure container within the mobility device. The secure container can comprise hardware, firmware, and software components so as to reduce opportunities for mischief. In the illustrative implementation, the mobility device in being able to handle forensic evidence can be used to comply with higher expectations relating to evidentiary procedure.

In another illustrative implementation, the mobility device platform can provide a computer network system that provides a mobility device having a customizable and portable desktop computing environment (“Mobile Desktop Environment (MDE)”). In an illustrative operation, the MDE can be presented to a cooperating electronic host environment to allow participating users controls over the MD using one or more peripherals of the cooperating electronic host environment. In the illustrative operation, the MDE can be used to retrieve data from the MD (or a cooperating one or more of MDMS) as well as launch executables for execution on the MD (e.g., the executables found on the MD and/or provided by a cooperating one or more of the MDMS). The executables can be displayed by the MD through a display device of the cooperating electronic host environment (e.g., in this context the cooperating electronic host enviorment can include but is not limited to a personal copmuter, laptop computer, or the like).

In another illustrative implementation, the mobility device platform can comprise a mobile personal server (MPS) that is capable of porting and operating on applications and data files across a plurality of cooperating electronic host environments. In the illustrative implementation, the MPS can maintain the required computing power and memory to accomplish such porting and operating functions. In an illustrative operation, the MPS can be used as a local data/applications server to a cooperating electronic host environment such that a participating user can access desired data and/or applications (e.g., executables) from the MPS.

In an illustrative operation, the mobility device of an exemplary mobility device platform can present itself to the cooperating electronic host environment as one or more accepted peripherals to allow the mobility device to “mount” onto the cooperating electronic host environment. In an illustrative operation, the mobility device can be operable to configure any physical or virtual device through a selected USB/CD-ROM startup procedure. In the illustrative operation, the mobility device can operated to create a “pass-through” device driver so that the required output driver can be virtualized remotely. In the illustrative operation, the mobility device that which can be presented to the cooperating electronic host environment as a USB/CD-ROM can operate to load software onto the cooperating electronic host environment such that the loaded software can probe the cooperating electronic host environment to retrieve an IP address. In the illustrative operation, the retrieved IP address can be transferred to the mobility device so the mobility device can re-present itself to the cooperating electronic host environment as a USB/Ethernet-network interface card (NIC) and not as a virtual hub (e.g., USB/CD-ROM device). In the illustrative operation, the USB/CD-ROM presented mobility device can read sequentially one file name from four sets of empty files in selected data storage locations. In the illustrative operation, each of the file names can have a name such that it can be a number from 0 to 255. In the illustrative operation, the mobility device acting as a USB/CD-ROM device, can operate to interpret the file name from each of the four sets of empty files to be a part of an IP address (e.g., reading f0/[0-255].f1/[0-255].f3[0-255].f4[0-255]). In the illustrative operation, once the mobility device interprets the IP address, the mobility device can un-mount as a USB/CD-ROM and remount as a NIC configured to the IP address that the mobility device interpreted.

In another illustrative operation, the mobility device can present itself to the cooperating electronic host environment as two files (e.g., an input file and an output file). This presentation allows the mobility device to interact with the cooperating electronic host environment without conflicting with firewall protections found on the cooperating electronic host environment. In the illustrative operation, the input file can be used by the mobility device to present data/executables to the cooperating host environment and the output file can be used to present data/executables/instructions to the mobility device.

In another illustrative implementation, the mobility device can comprise software and/or hardware components that allow the mobility device to securely boot the operating system found on the mobility device and to allow the mobility device to load and execute trusted (e.g., signed) software code segments onto a cooperating electronic host environment. In an illustrative operation, the mobility device performs a secure boot of the mobility device operating system which is completely independent of any operating system found on a cooperating electronic host environment. The secure boot of the mobility device operating system can be accomplished by discrete hardware and software components found on the mobility device including but not limited to secure memory elements, redundant and compartmentalized processing elements, and selected instructions instructing the discrete hardware components to perform a secure boot operation.

In another illustrative implementation, the mobility device can comprise software and/or hardware components that allow the mobility device to boot the mobility device within a cooperating electronic host environment. In an illustrative operation, the mobility device can operate to perform a selected parasitic injection and configuration of the cooperating electronic host environment to allow the mobility device and cooperating electronic host environment to operate together (e.g., to boot up together) as if the mobility device and cooperating electronic host environment were not operating independently.

In another illustrative implementation, the exemplary mobility device platform can provide base infrastructure services for operation and deployment on cooperating electronic host environments as accomplished by cooperation between the various components of the exemplary mobility device platform (e.g., mobility device, cooperating electronic host environment, and mobility device management server). Such infrastructure services can include but are not limited to security (confidentiality, integrity, authentication, and authorization), identity, identity attributes, subscription management, billing and account management, license management, and content management.

In another illustrative implementation, the exemplary mobility device platform can comprises a license management engine capable of separating license grants from bundles of content, which in turn can enable flexible and secure content distribution and licensing models including but not limited to pass-through license transfers. In an illustrative operation, the licensing engine can reside as hardware and/or software on the mobility device and/or mobility device management server. In the illustrative operation, a license grant can be purchased by a participating user of the mobility device and stored on the mobility device. The stored license grant can then be communicated for storage and processing on one or more cooperating mobility device management servers for subsequent use. In the illustrative operation, a participating user can invoke the purchased license grant by deploying the mobility device on a cooperating electronic host environment (e.g., a participating user purchases an expiring license to a movie and uses the mobility device on a cooperating digital video recorder (DVR) to invoke the purchased license; responsive to the invocation of the license, the DVR can cooperate with cooperating components—e.g., MDMS and/or content servers having the movie content, to retrieve the movie for display to the participating user).

In another illustrative implementation, the exemplary mobility device platform can comprise a role definition and management engine that can be operable to separate the roles of a participating user (e.g., roles that a participating user may play—e.g., persona) and host the associated security elements (e.g., encryption keys), user profiles, files, and content separately and securely from each other to avoid overlap and contamination of such role information. In the illustrative implementation, the role definition and management engine can reside as hardware and/or software on the mobility device and/or mobility device management server. In an illustrative operation, the persona can be projected onto a cooperating electronic host environment to generate an aura for use and execution on the cooperating electronic host environment.

In another illustrative implementation, the exemplary mobility device platform comprises a mobility device capable of injecting a BIOS and/or virtual machine onto a cooperating electronic host environment such that applications can be executed on the injected virtual machine through a selected license borrowing paradigm. In an illustrative operation, the mobility device can identify the license grants available to the mobility device by the cooperating electronic host environment. In the illustrative operation, the mobility device can operate to inject a virtual machine (and/or required BIOS) onto the cooperating electronic host environment and can execute one more applications on the injected virtual machine using one or more licenses grant found on the cooperating electronic host environment. For example, the cooperating electronic host environment can comprise a license to a word processing application. The mobility device, in an illustrative operation, can identify the word processing application license on the cooperating electronic host environment, borrow the license from the cooperating electronic host environment, and inject a virtual machine executing a separate and independent instance of the same word processing application executable on the borrowed license.

In another illustrative implementation, the exemplary mobility device platform can comprises a mobility device having one or more of the following mechanisms capable of performing one or more of the following features/operations: a mechanism for keeping attackers from changing the system clock of the mobility device or preventing the mobility device from synchronizing with a secure system clock; a mechanism for separating the roles, rights and privileges of the owner of the mobility device from the user of the mobility device, and the manager of the MPS; a mechanism for importing data from GSM cards and other electronic identity cards; a mechanism for checking state, diagnose, copy files to/from, repair, disable, backup and secure a cooperating electronic host environment; a mechanism for enabling smart documents, such as a passport with an embedded RFID tag to enable RFID reads via proximity to a user-activated mobility device (In an illustrative operation, the passport can be activated via bio-metric data at the point of entry into a country, otherwise the passport could operate to remain deactivated). Additionally, in the context of smart documents, the mobility device can operate such that the RFID is enabled via one or more signals: within a ‘cage’, which provides one signal. The mobility device, with optional user authentication, provides another signal, RFID tag can be read/written/zero'd/disabled, RFID tag may be emulated, where single ‘smart’ RFID tag emulates multiple ‘stupid’ or ‘single’ RFID tags; a mechanism for tracking and managing smart electronic and RFID-embedded paper documents; a mechanism for providing limited access to federal law enforcement data to local law enforcement officials and vice-versa; a mechanism for providing access to local or remote financial information and applications with or without single-sign-on.

In the illustrative implementation, the mobility device can further comprise one or more of the following mechanisms operating to perform one or more of the following operations/features: a mechanism for discretely and granularly selecting which pieces of medical data will be provided to a participant in the health care system; a mechanism for allowing doctors roaming access to computing resources while maintaining compliance with Health Insurance Portability and Accountability Act (HIPAA) regulations; a mechanism for indicating to environmental controllers (e.g. home, car) the preferences of an mobility device holder in proximity to those controllers; a mechanism for providing “project trust” or mapping rights and permissions to other devices within the environment. (Policies and device profiles dictate which devices are afforded various trust levels. Rights, permissions and keys can be mapped within the mobility device from the mobility device's internal “rights vault” to those required to support various digital rights management schemes. Content is played in degraded form on those devices that are not highly trusted.); a mechanism for providing “melded trust” or allowing external playback devices within the local environment to utilize the content protection capabilities of the mobility device; a mechanism for automatically optimizing or manually managing the scattering and allocation of data and computational resources for network-hosted tasks; a mechanism for providing multi-factor authentication of the user (e.g., factors can include: possession, knowledge of a secret, and a biometric such as fingerprint.); a mechanism for providing that intermittently connected devices can be correlated with “always-running” processes or software agents with the ability to “park” the mobility device based on manual configuration or an automatically based on parameters of the mobility device and/or cooperating electronic host environment including: operating environment computational capacity (MIPS) and scalability, security of the operating environment, content licensing (rights management) capability, system management capabilities, operating environment stability (uptime), operating environment accessibility, network bandwidth and latency, and storage capacity; a secure time-service, and data-record time stamping and archival; a secure location verification service, local network connectivity, or the like; a software or hardware accelerated implementation of voice over IP (VoIP); a software or hardware-accelerated implementation of SDR (software defined radio); a mechanism for streaming, encoding, decoding, transcoding and watermarking of digital media, including voice (bi-directional), audio (unidirectional or broadcast), video and pictures; a plurality of interfaces (e.g., USB, Ethernet, etc.) on the mobility device; an X-windows proxy system, through which display commands from a local mobility device or remote software application (e.g., originating from cooperating MDMS) can be routed to a local cooperating electronic host environment display service, a remote display service (e.g., a display service on a remote cooperating electronic environment), or both.

In the illustrative implementation, the mobility device can further comprise one or more of the following mechanisms operating to perform one or more of the following operations/features: a mechanism to import or export global system for mobile communications (GSM) data via a wired or wireless link (e.g., the GSM data can then be projected and managed). a mechanism to connect to a high-resolution screen; a mechanism to track internet access usage by user or software program, and cache access pattern information, and specific content; connectivity to a network through powered Ethernet.

In the illustrative implementation, the mobility device platform can further comprise one or more of the following mechanisms operating to perform one or more of the following operations/features: provides for a platform to allow for dynamic and effective project collaboration using expiring user rights and authentication; provides for a per-use (per-use of feature) licensing model for applications and services; provides for content aggregation of application drivers; provides for content integration and single-sign on; provides for RAM borrowing from a local environment; provides for a virtualization of a gaming system; provides for bi-directional trust arbitration to allow extended security perimeters of existing services models; provides for multi authentication of a user using a selected sequence of fingerprint inputs (finger print is first layer, second layer of authentication is through sequence of finger prints—i.e., first third and fourth finger).

It is appreciated that although the exemplary mobility device platform is described herein to maintain various mechanisms performing various operations and functions that such description is merely illustrative as the inventive concepts described herein can extend to a mobility device platform having other mechanisms performing other features and operations. It is further appreciated that the mechanisms described herein can be realized through software and/or hardware, alone or in combination to perform the described operations and features.

Application Services:

Services provided over the communications network such as the Internet, commonly referred to as application services, are evolving. Likewise, technologies that facilitate such services are also evolving. A web service can be defined as any information source running business logic processes conveniently packaged for use by an application or end-user. Web services are increasingly becoming the means through which one can provide functionality over a network. Web services typically include some combination of programming and data that are made available from an application server for end users and other network-connected application programs. Web services range from such services as storage management and customer relationship management down to much more limited services such as the furnishing of a stock quote and the checking of bids for an auction item.

Activities focusing on defining and standardizing the use of web services include the development of Web Services Description Language (WSDL). WSDL is an Extensible Markup Language (XML) format for describing web services as a set of endpoints operating on messages containing either document-oriented or procedure-oriented information. The operations and messages are described abstractly, and then bound to a concrete network protocol and message format to define an endpoint. Related concrete endpoints are combined into abstract endpoints (services).

Currently, the advocated web service usage model is generally as follows.

(1) Services are implemented and deployed on one site, often referred to as the server side.

(2) Services are described using WSDL and are published via means such as UDDI (Universal Description, Discovery, and Integration), which is an XML-based registry for businesses worldwide to list themselves on the Internet by the web services they offer.

(3) Client applications use web services at another site, often referred to as the client side, by first interpreting one or more WSDL documents. Once interpreted, the clients can understand the characteristics of the associated service(s). For example, service characteristics may include service API specifications such as (a) input data type, (b) service input data format, (c) service access mechanism or style (e.g., RPC versus messaging), and (d) related encoding format.

(4) Client applications prepare their data in manners in which various particular web services understand.

(5) Client applications invoke a particular service according to the manner specified for the service, such as in an associated WSDL document.

Many differences exist among web services with respect to the format of input data and the manner in which they are invoked. For example, suppose one application service provider provides a service, getCityWeather, that requires a single input parameter, such as a conventional city name (e.g., SLC for Salt Lake City). A client application that intends to invoke such a service needs to be written so that data within or output by the application is able to be analyzed to extract the city information. At runtime, the prepared symbol is passed to the getCityWeather service site using appropriate APIs.

However, suppose another application service provider provides a similar service that requires two input parameters, such as the city name and the zip code. Hence, if a client application intends to invoke this second service, it needs to analyze and extract its data appropriately in regards to the required service input parameters. Therefore, if a single application was intended to invoke both services, the application would have to be hard-coded with service-specific API information and procedures. Furthermore, if the application was intended to invoke numerous services, the application would have to be hard-coded with service-specific API information and procedures related to each and every service that it intended to invoke.

As explained above, various web services may provide similar functionality but differ in many ways. The herein described system and methods aim to ameliorate such disparity by offering a mobility device platform having a mobile device management server which includes, among other things, a web services translation module operative to accept data from web services web services providers and present them in a web service model native to cooperating mobility devices.

Simple Object Access Protocol (SOAP) Overview:

In the context of data communications, there are various messaging transport protocols including but not limited to hyper-text transfer protocol (HTTP) file transport protocol (FTP). In relation to the messaging transports, simple object access protocol can be considered to be message content. SOAP can be used in various operations including but not limited to file transfer, message transfer, notification, request/response, and asynchronous request/response. Further, the message content formats can include but are not limited to hyper-text mark-up language (HTML), extensible mark-up language (XML), SOAP, RMI, and COBRA.

The Simple Object Access Protocol (SOAP) is a lightweight, XML-based protocol for exchanging information in a decentralized, distributed environment. SOAP supports different styles of information exchange, including:

Remote Procedure Call style (RPC), which allows for request-response processing, where an endpoint receives a procedure oriented message and replies with a correlated response message.

Message-oriented information exchange, which supports organizations and applications that need to exchange business or other types of documents where a message is sent but the sender may not expect or wait for an immediate response.

Generally, a SOAP message consists of a SOAP envelope that encloses two data structures, the SOAP header and the SOAP body, and information about the name spaces used to define them. The header is optional; when present, it conveys information about the request defined in the SOAP body. For example, it might contain transactional, security, contextual, or user profile information. The body contains a Web Service request or reply to a request in XML format. The high-level structure of a SOAP message is shown in the following figure.

SOAP messages, when used to carry Web Service requests and responses, can conform to the web services definition language (WSDL) definition of available Web Services. WSDL can define the SOAP message used to access the Web Services, the protocols over which such SOAP messages can be exchanged, and the Internet locations where these Web Services can be accessed. The WSDL descriptors can reside in UDDI or other directory services, and they can also be provided via configuration or other means such as in the body of SOAP request replies.

There is a SOAP specification (e.g. w3 SOAP specification—found at www.w3.org) that provides a standard way to encode requests and responses. It describes the structure and data types of message payloads using XML Schema. The way that SOAP may be used for the message and response of a Web Service is:

The SOAP client uses an XML document that conforms to the SOAP specification and which contains a request for the service.

The SOAP client sends the document to a SOAP server, and the SOAP servlet running on the server handles the document using, for example, HTTP or HTTPS.

The Web service receives the SOAP message, and dispatches the message as a service invocation to the application providing the requested service.

A response from the service is returned to the SOAP server, again using the SOAP protocol, and this message is returned to the originating SOAP client.

It is appreciated that although SOAP is described herein as a communication protocol for the herein described systems and methods that such description is merely illustrative as the herein described systems and methods may employ various communication protocols and messaging standards.

Illustrative Computing Environment

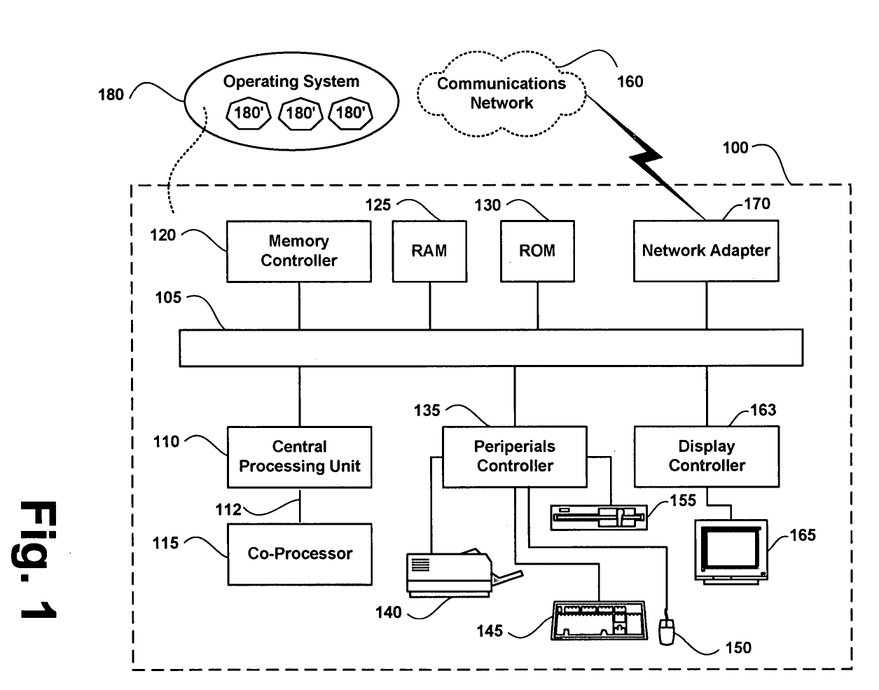

FIG. 1 depicts an exemplary computing system 100 in accordance with herein described system and methods. Computing system 100 is capable of executing a variety of operating systems 180 and computing applications 180′ (e.g. web browser and mobile desktop environment) operable on operating system 180. Exemplary computing system 100 is controlled primarily by computer readable instructions, which may be in the form of software, where and how such software is stored or accessed. Such software may be executed within central processing unit (CPU) 110 to cause data processing system 100 to do work. In many known computer servers, workstations and personal computers central processing unit 110 is implemented by micro-electronic chips CPUs called microprocessors. Coprocessor 115 is an optional processor, distinct from main CPU 110, that performs additional functions or assists CPU 110. CPU 110 may be connected to co-processor 115 through interconnect 112. One common type of coprocessor is the floating-point coprocessor, also called a numeric or math coprocessor, which is designed to perform numeric calculations faster and better than general-purpose CPU 110.

It is appreciated that although an illustrative computing environment is shown to comprise a single CPU 110 that such description is merely illustrative as computing environment 100 may comprise a number of CPUs 110. Additionally computing environment 100 may exploit the resources of remote CPUs (not shown) through communications network 160 or some other data communications means (not shown).

In operation, CPU 110 fetches, decodes, and executes instructions, and transfers information to and from other resources via the computer's main data-transfer path, system bus 105. Such a system bus connects the components in computing system 100 and defines the medium for data exchange. System bus 105 typically includes data lines for sending data, address lines for sending addresses, and control lines for sending interrupts and for operating the system bus. An example of such a system bus is the PCI (Peripheral Component Interconnect) bus. Some of today's advanced busses provide a function called bus arbitration that regulates access to the bus by extension cards, controllers, and CPU 110. Devices that attach to these busses and arbitrate to take over the bus are called bus masters. Bus master support also allows multiprocessor configurations of the busses to be created by the addition of bus master adapters containing a processor and its support chips.

Memory devices coupled to system bus 105 include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process's virtual address space unless memory sharing between the processes has been set up.

In addition, computing system 100 may contain peripherals controller 135 responsible for communicating instructions from CPU 110 to peripherals, such as, printer 140, keyboard 145, mouse 150, and data storage drive 155.

Display 165, which is controlled by display controller 163, is used to display visual output generated by computing system 100. Such visual output may include text, graphics, animated graphics, and video. Display 165 may be implemented with a CRT-based video display, an LCD-based flat-panel display, gas plasma-based flat-panel display, a touch-panel, or other display forms. Display controller 163 includes electronic components required to generate a video signal that is sent to display 165.

Further, computing system 100 may contain network adaptor 170 which may be used to connect computing system 100 to an external communication network 160. Communications network 160 may provide computer users with means of communicating and transferring software and information electronically. Additionally, communications network 160 may provide distributed processing, which involves several computers and the sharing of workloads or cooperative efforts in performing a task. It will be appreciated that the network connections shown are exemplary and other means of establishing a communications link between the computers may be used.

It is appreciated that exemplary computer system 100 is merely illustrative of a computing environment in which the herein described systems and methods may operate and does not limit the implementation of the herein described systems and methods in computing environments having differing components and configurations as the inventive concepts described herein may be implemented in various computing environments having various components and configurations.

Illustrative Computer Network Environment:

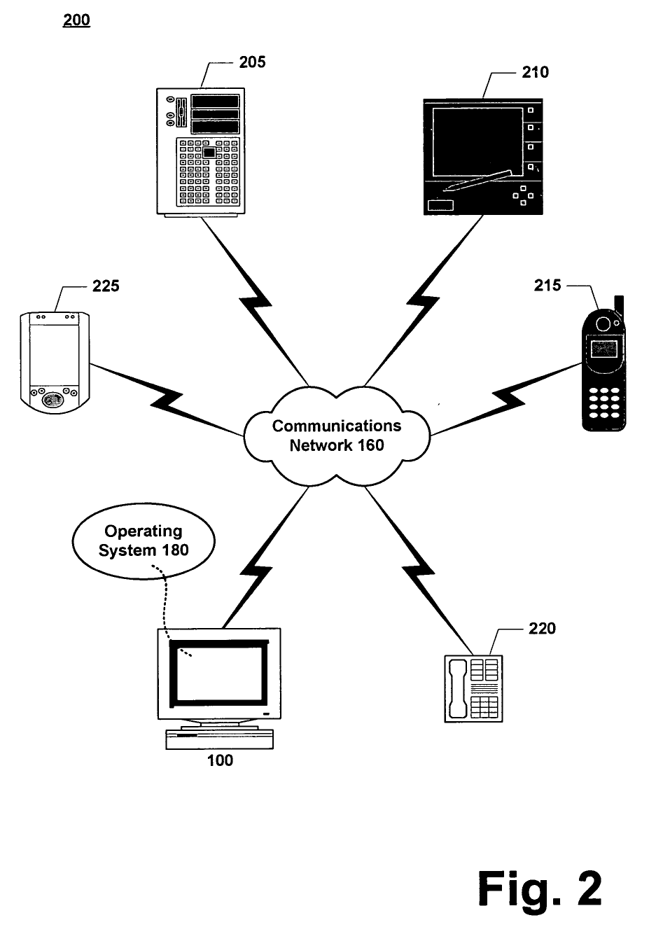

Computing system 100, described above, can be deployed as part of a computer network. In general, the above description for computing environments applies to both server computers and client computers deployed in a network environment. FIG. 2 illustrates an exemplary illustrative networked computing environment 200, with a server in communication with client computers via a communications network, in which the herein described systems and methods may be employed. As shown in FIG. 2 server 205 may be interconnected via a communications network 160 (which may be either of, or a combination of a fixed-wire or wireless LAN, WAN, intranet, extranet, peer-to-peer network, the Internet, or other communications network) with a number of client computing environments such as tablet personal computer 210, mobile telephone 215, telephone 220, personal computer 100, and personal digital assistance 225. Additionally, the herein described systems and methods may cooperate with automotive computing environments (not shown), consumer electronic computing environments (not shown), and building automated control computing environments (not shown) via communications network 160. In a network environment in which the communications network 160 is the Internet, for example, server 205 can be dedicated computing environment servers operable to process and communicate web services to and from client computing environments 100, 210, 215, 220, and 225 via any of a number of known protocols, such as, hypertext transfer protocol (HTTP), file transfer protocol (FTP), simple object access protocol (SOAP), or wireless application protocol (WAP). Each client computing environment 100, 210, 215, 220, and 225 can be equipped with browser operating system 180 operable to support one or more computing applications such as a web browser (not shown), or a mobile desktop environment (not shown) to gain access to server computing environment 205.

In operation, a user (not shown) may interact with a computing application running on a client computing environments to obtain desired data and/or computing applications. The data and/or computing applications may be stored on server computing environment 205 and communicated to cooperating users through client computing environments 100, 210, 215, 220, and 225, over exemplary communications network 160. A participating user may request access to specific data and applications housed in whole or in part on server computing environment 205 using web services transactions. These web services transactions may be communicated between client computing environments 100, 210, 215, 220, and 220 and server computing environments for processing and storage. Server computing environment 205 may host computing applications, processes and applets for the generation, authentication, encryption, and communication of web services and may cooperate with other server computing environments (not shown), third party service providers (not shown), network attached storage (NAS) and storage area networks (SAN) to realize such web services transactions.

Thus, the systems and methods described herein can be utilized in a computer network environment having client computing environments for accessing and interacting with the network and a server computing environment for interacting with client computing environments. However, the systems and methods providing the mobility device platform can be implemented with a variety of network-based architectures, and thus should not be limited to the example shown. The herein described systems and methods will now be described in more detail with reference to a presently illustrative implementation.

Mobility Device Platform:

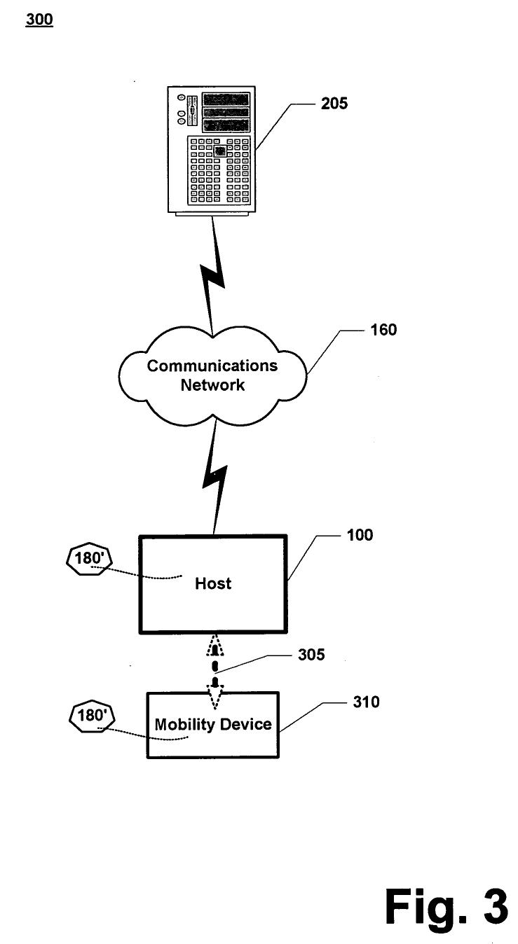

FIG. 3 shows an exemplary interaction between the components of an exemplary mobility device platform. Generally as is shown in FIG. 3, exemplary mobility device platform 300, in simple terms, can comprise mobility device 310 cooperating with cooperating electronic host environment (CEHE) 100 using communications interface 305 operating on a selected communications protocol (not shown). Additionally, exemplary mobility device platform 300 may further comprise communications network 160 (of FIG. 1) and server computing environment 205.

In operation mobility device may cooperate with cooperating electronic host environment 100 through communications interface 305 to execute one or more executables 180′ originating from mobility device 310 and displayable for user interaction on cooperating electronic host environment 100. Executable 180′ may include but are not limited to, a browser application offering the look and feel of conventional operating systems, word processing applications, spreadsheets, virtual machines, content management applications, license management engine, infrastructure services, database applications, web services applications, and user management/preference applications, etc. Additionally, mobility device 310 may cooperate with server computing environment 205 via communications network 160 using CEHE 100 to obtain data and/or computing applications in the form of web services.

It is appreciated that mobility device 310 can act as a “smart cable” capable of acting as the interface for other devices (not shown) to the cooperating electronic host environment 100. In an illustrative implementation, mobility device 310 can comprise one or more receiving interface inputs (not shown) allowing the mobility device to provide access to cooperating electronic host environment 100 to one or more other cooperating devices (e.g., personal digital assistant). Included in the access provided to the cooperating electronic host environment, in the illustrative implementation, can be access to one or more peripherals coupled to cooperating electronic host environment 100 (e.g., display, keyboard, mouse, etc.—not shown). such that a participating user can employ the coupled peripherals of cooperating electronic host environment 100 to navigate and interface with data on the other cooperating device (not shown). As such, mobility device 310 can operate as an intelligent pass through allowing the other cooperating device to cooperate with cooperating electronic host environment 100.

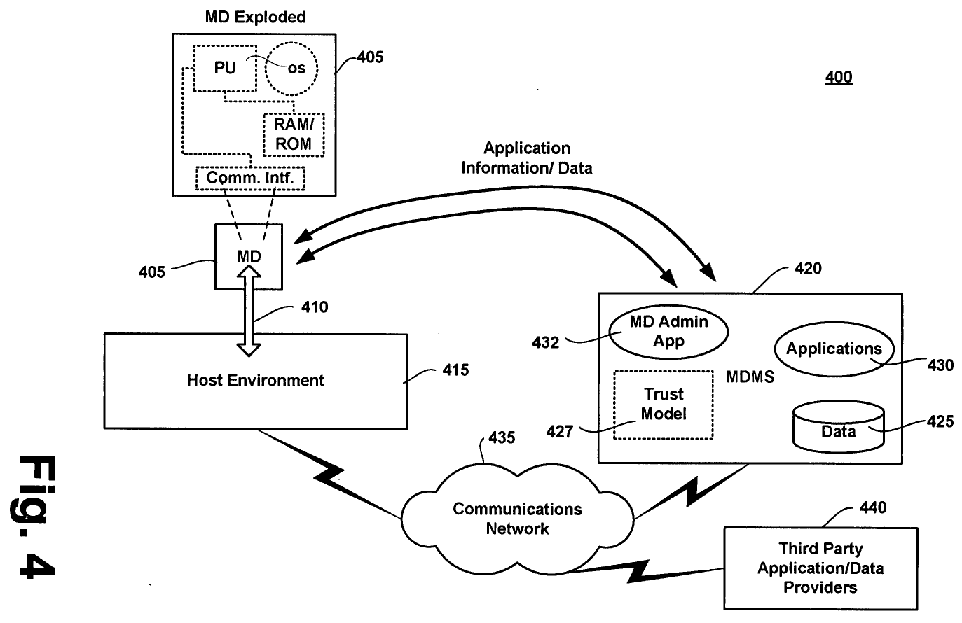

FIG. 4 shows the interaction of components for exemplary mobility device platform 400. As is shown in FIG. 4, exemplary mobility device platform 400 comprises mobility device (MD) 405, cooperating electronic host environment (CEHE) 410, communications network 435, mobility device management server (MDMS) 420 and third party web service providers 440. Additionally, as is further shown in the MD exploded view, MD 405 further comprises processing unit (PU), operating system (OS), storage memory (RAM/ROM), and an MD communications interface. Also, MDMS 420 further comprise trust model 427, data 425, applications (e.g., executables) 430, and mobility device admin application 432.

In operation, MD 405 can communicate with cooperating electronic host environment 410 using one or more of MD components PU, OS, RAM/ROM and MD communications interface through MD/computing environment communications interface. When communicating with cooperating electronic host environment 410, MD 405 can execute one or more executables (e.g., applications—not shown) that can include but are not limited to, a mobile desktop environment, user customization and authentication manager, and other executables as part of a configuration process. Once configured, MD 405 can further cooperate with CEHE 410 to process one or more web services (e.g. web service data and/or computing applications). In such context, MD 405 can communicate with cooperating MDMS 420 using communications network 435 request and process data and/or executables. In such instance, MDMS 420 may operate to authenticate MD 405 to ensure that the participating user (not shown) and mobility device 405 have the correct privileges to the requested data and/or executables according to selected trust model 427. In an illustrative implementation, trust model 427 can comprise one or more instructions to instruct MD 405 and/or MDMS 420 to perform authentication and verification processes. Additionally, in the illustrative implementation, trust model 427 can comprise one or more parameters for use as part of the authentication/verification process.

In an illustrative implementation, MD 405 can operate to execute processes local to MD 405 and cooperate with cooperating electronic host environment 410 to display data and receive instructions/interface inputs from one or more of peripherals (not show) that can be coupled to cooperating electronic host environment. In another illustrative implementation, MF 405 can operate to share processing of instructions and executables with the processing resources found on cooperating electronic host environment. In the illustrative implementation, processes can be spawned, suspended, resumed, terminated, or migrated based on policy or command of MD 405. Further in the illustrative implementation, an operating environment can be loaded onto cooperating electronic host environment 410 by MD 405 as part of a data processing and execution of one or more executables.

If properly authenticated, MDMS 420 can further operate to locate the requested data and/or executables locally to MDMS 420 and provide such requested data and/or executables (e.g., applications, services, etc.) to the authenticated MD 405 over communications network 435, or operate to cooperate with third party services providers 440 to obtain the requested data and/or executables for communication to the authenticated MD 405. When cooperating with third party web services providers 440, MDMS 420 may operate to translate the data and/or executables (e.g., originating on a legacy server and presented to MD 405 through a presentation server (not shown)) originating from third party web services providers 440 to an MD native format. Additionally, MDMS 420 can operate to encrypt requested data and/or executables using when satisfying requests for data and/or executables from authenticated MD 405 according to selected trust model 427.

Additionally, MDMS 420 can further operate to cooperate with a file system (not shown) using a selected encryption protocol (e.g. PKI encryption) to obtain the requested data for communication to MD 405. The cooperating file system may include but is not limited to file allocation table (FAT) file systems and new technology files system (NTFS).

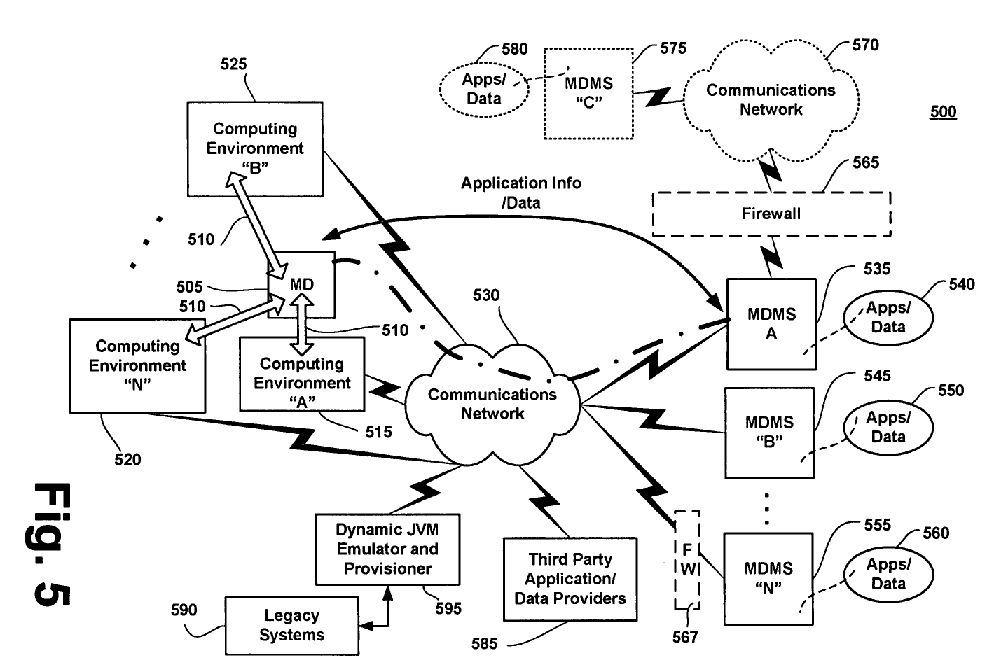

FIG. 5 shows another illustrative implementation of an exemplary mobility device platform. As is shown mobility device platform 500 comprises MD 505 cooperating with a plurality of computing environments, computing environment “A” 515, computing environment “B” 525, up to computing environment “N” 520 through MD/computing environment communications interface 510. Additionally, mobility device platform 500 further comprises communications network 530 third party services providers 585, java virtual machine (JVM) emulator and provisioner, plurality of MDMS, MDMS “A” 535 operating on applications/data 540, MDMS “B” operating on applications/data 550, up to MDMS “N” 555 operating on applications/data 560 operating through firewall 567. Additionally, as indicated by the dotted lines, mobility device platform 500 may further comprise, in another illustrative implementation, MDMS “C” operating on web services 580, communications network 570, and firewall 565.

In an illustrative operation, mobility device 505 cooperating with one or more of computing environments 515, 525, up to 520 may process data and/or executables for navigation and control on computing environments 515, 525, up to 520. In such context, MD 505 may request data and/or executables (e.g., applications, services, etc.), 540, 550, or 560 from one ore more cooperating MDMS 535, MDMS 545, up to MDMS 555 via communications network 530. In this occurrence, any of the MDMS, 535, 545, up to 555 can operate to authenticate the requesting MD 505 to ensure that MD 505 has the right user rights, permissions, and privileges to obtain the requested data and/or executables according to a selected trust model (not shown). Upon successful authentication and verification, MDMS 535, 545, up to 555 may operate to process MD 505's request and provide the requested data and/or executables. MDMS 535, 545, up to 555, can further operate to translate the requested data and/or executables (if required—e.g. data and/or executables originates from third party providers 585) to an MD 505 native web service format. Additionally, MDMS 535, 545, up to 555, may operate to encrypt the requested data and/or executables using MD and user authentication and verification information to ensure that the requested data and/or executable is communicated over communications network 530 in a secure manner.

Furthermore, mobility device platform 500 may operate to obtain legacy data and/or computing applications by employing java virtual machines. In this context, MD 505 can cooperate with a dynamic JAVA virtual machine (JVM) emulator and provisioner (which although not shown may comprise a portion of one or more of MDMS 535, 545, up to 555) to request data and/or computing applications from legacy systems 590. Dynamic UVM emulator and provisioner 595 may operate to cooperate with legacy systems 590 to obtain the requested data and/or computing applications from the requesting MD 505. In this context, dynamic JVM emulator and provisioner may generate one or more java virtual machines that operate on the legacy system to present the requested data and computing applications as a web service to MD 505. Also, similar to MDMS operations, dynamic JVM emulator and provisioner may first authenticate MD 505 prior to obtaining the requested information.

Mobility device platform 500 further allows for the use of multiple workspaces by mobility device 505. Stated differently, a single mobility device 505 may operate to support a number of “personas” for participating users. For example, a participating user (not shown) may choose to use the same mobility device for corporate use and several personal uses. In this context, the mobility device may operate to provide a plurality of “work spaces” (e.g., define various personas) within the mobility device such that each work space is governed by its own set of user/device authentication and verification information. Accordingly, when a participating user (not shown) wishes to retrieve information from their corporate network (e.g. assume MDMS “A” 535 is a corporate server) they may log onto MD 505 and activate the first work space (not shown) by using the participating user's corporate user authentication and identification information. The corporate MDMS (e.g. MDMS “A” 535 for purposes of this illustration) proceeds to authenticate the user based on the user's corporate user authentication and verification information, and if authenticated, may process a data and/or executable request for MD 505 via communications network 530 (e.g. corporate LAN for purposes of this illustration). Since the participating user is authenticated on the corporate MDMS “A” 535 using the corporate user identification and verification information, data and/or computing applications provided to MD 505 under such circumstances is ensured to be communicated securely (e.g., over an established virtual private network (VPN) as indicated by the dot-dash line) to the properly authenticated participating user.

Similarly, if the participating user (not shown) wishes to access their gaming data and/or executables (e.g. MDMS “C” 580) from a cooperating gaming content provider, the participating user can proceed to switch his/her “persona” by activating a second work space (not shown) on MD 505. The user may invoke the gaming work space by logging off their corporate workspace and logging on the gaming work space using his/her gaming user id and password (e.g. user authentication and verification information). In this context, the participating user may access MDMS “C” 575 through a daisy chain, first getting to MDMS “A” 535 through communications interface 530 and then to gaming data and/or executables MDMS “C” 580 through the corporate firewall 565 and via external communications network 570 (e.g. Internet). As such, a participating user may use a single MD having multiple workspaces (and personas) to realize their corporate and personal computing needs in a secure manner by leveraging the various user authentication and verification information.

From the foregoing it is appreciated that mobility device platform 500 is capable of operating in a manner such that a single mobility device may interact with a plurality of disparate computing environments. Examples of cooperating computing environments include but are not limited to stand alone computing environments, networked computing environments, and embedded computing environments. In the context of embedded computing environments, the herein described systems and methods can be employed to allow for interaction (e.g., the projection of a persona) with embedded automotive computing environments to customize automotive driving and comfort settings (e.g. the mobility device may be configured to have a participating user's driving and comfort settings stored such that when the participating user is in the mobility the mobility device cooperates with the embedded automotive computing environment according to a selected communications interface and protocol to set the driving and comfort settings of the automobile in accordance with the stored settings). Similarly, in context with embedded electronic computing environments, a mobility device can operate to facilitate the retrieval of multimedia from a variety of disparate locations. In such illustration, the mobility device may have stored thereon digital rights and licenses to multimedia and cooperate with one ore more consumer electronic having an embedded computing environment through a selected communications interface and communications protocol (e.g. wireless Internet Protocol) to obtain stored multimedia. Stated differently, an MP3 enabled receiver can have stored thereon or have the capability of retrieving through an external communications network (e.g. Internet) a plurality of MP3 songs. These songs may only be accessible according to specific digital rights management and/or user licenses. Accordingly, exemplary mobility device platform 500 may operate to provide a participating user access to such songs by communicating through a rights and content management application the required rights and licenses to the cooperating MP3 enabled receiver.

It is appreciated that although mobility device platform 500 is shown to have a particular configuration and operable on various components, that such description is merely illustrative as the herein described systems and methods that comprise exemplary mobility device platform 500 may be realized through various alternate configurations and components.

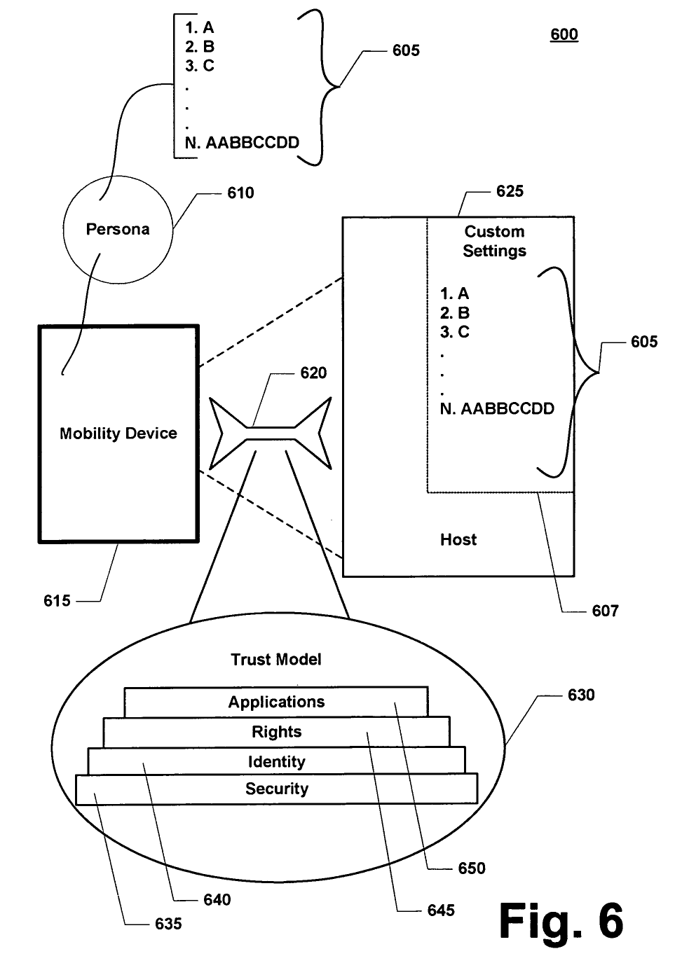

FIG. 6 shows the interaction between components of exemplary mobility device platform 600. As is shown, exemplary mobility device platform 600 comprises mobility device 615, communications interface 620, and cooperating electronic host environment (CEHE) 625, and trust model 630. Further, as is shown, mobility device comprises persona 610 having persona parameters 605. Additionally, CEHE 625 further comprises projected persona (e.g., aura) 607 having persona parameters 605. Additionally, as is shown trust model 630 further comprises trust model components including but not limited to security component 635, identity component 640, right component 645, and applications component 650.

In an illustrative operation, mobility device 615 can mount to CEHE 625 through communications interface 620. In the illustrative operation, mobility device 615 can store a “persona” (e.g., custom preferences, rights, authentications, and privileges) 610 for projection onto CEHE 625 to generate aura 607. Persona 610 can comprise persona parameters 605 that are communicable to CEHE 625 by mobility device 615 for use on CEHE 625. Further, in the illustrative operation, mobility device can operate to “mount” onto CEHE 625 according to trust model 630. In the illustrative operation, trust model 630 can comprise instructions to the mobility device 615 to allow mobility device 615 to communicate one or more persona parameters 605 when generating and presenting aura 607 on CEHE 625.

In an illustrative implementation, trust model 630 can comprise various components including but not limited to security component 635, identity component 640, rights component 645, and applications component 650. In an illustrative operation, security component 635 of trust model 630 can operate to establish rules and requirements to establish secure communications and data/executable exchange between mobility device 615 and other cooperating components (e.g., CEHE 625, MDMS (not shown), etc.). In the illustrative operation, the security requirements can be defined by the intended use of the mobility device 615, the privileges of the mobility device (e.g., privileges of the participating user of the mobility device) that can be ascertained from identity component 640 of trust model 630. Additionally, trust model 630, in the illustrative implementation, provides the rights to the mobility device 615 for use in presenting various data/executables (e.g., applications 650), to other cooperating components in accordance with the trust model defined persona 610.

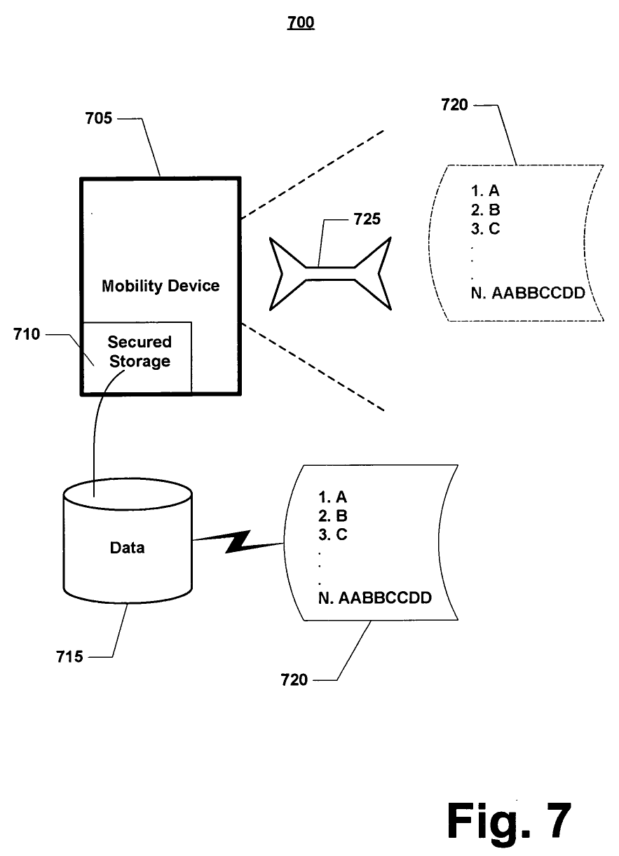

FIG. 7 shows a detailed implementation of a persona in exemplary mobility device platform 700. As is shown in FIG. 7, exemplary mobility device 700 comprises mobility device 705 having secured storage area 710 and communications interface 725. Additionally, as is shown, mobility device storage area 710 further comprises data store 715 capable of storing persona 720.

In an illustrative operation, mobility device 710 can store persona 720 (and personal parameters (not shown)) as defined by a selected trust model (not shown) in data store 715 residing as part of secured storage area 710. In the illustrative operation, persona 720 can then be projected as an aura (as illustrated by the dashed data box) 720 through communications interface 725 to other cooperating components (not shown) of exemplary mobility device platform 700. In the illustrative operation, persona 720 can be projected (as indicated by the dashed lines) to cooperating components according to a selected trust model (not shown).

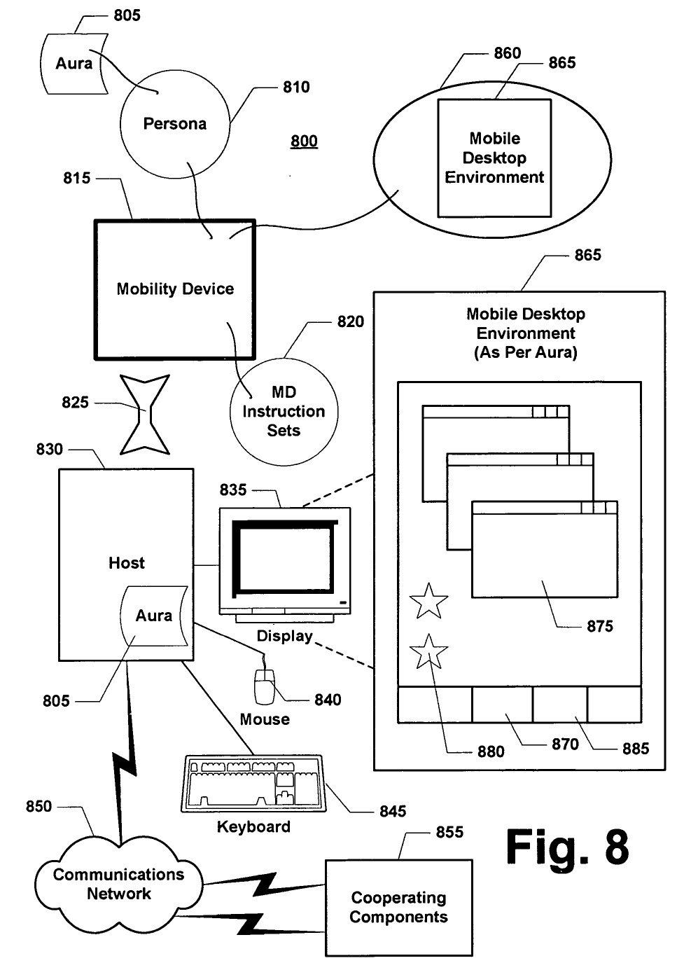

FIG. 8 shows another illustrative implementation of exemplary mobility device platform 800. As is shown in FIG. 8, exemplary mobility device platform 800 comprises mobility device 815, communications interface 825, and cooperating electronic host environment (CEHE) 830. Further, as is shown in FIG. 8, mobility device 815 further comprises persona 810 having persona parameters 805 (that when projected onto CEHE 830 generate an aura), mobile desktop environment 865 capable of executing on mobility device 815 in processing area 860, and mobility device instruction set 820. Further, as is shown in FIG. 8, CEHE 830 further comprises projected persona (i.e., aura) 805 and is coupled to communications network 850, keyboard 845, mouse 840, and display 835. Further, display 835 can be capable of displaying mobile desktop environment (as per aura definition) 867. Further, as is shown in FIG. 8, communications network 850 can be coupled to cooperating platform components 855.

In an illustrative operation, mobility device 815 can mount onto CEHE 830 according to one or more instructions provided by MD instruction sets 820 to project aura 805 onto CEHE 830. In the illustrative operation, mobility device 815 can operate execute mobile desktop environment (e.g., local execution on mobility device 815 and/or combination execution on mobility device 815 and CEHE 830) for display and navigation on display 835 that can be coupled to CEHE 830. In an illustrative implementation, displayed mobile desktop environment 867 can comprise navigation/display panes 875, shortcut launch buttons 880, and navigation buttons 870 and 885. In the illustrative operation, a participating user (not shown) can define aura 805 (based on the participating user's rights, privileges, and authentications) for projection onto CEHE 830. Based on the defined aura, the aura defined mobile desktop environment is executed by mobility device 815 for display through CEHE 830's coupled display 835. In the illustrative operation, the participating user (not shown) can interact with the aura defined mobile desktop environment 867 using one or more of keyboard 845 and mouse 840 that are coupled to CEHE 830 to execute executables and/or interact with data (e.g., executables/data local to CEHE 830, mobility device 815, and/or communicated by cooperating components 855 over communications network 850 to mobility device 815).

It is appreciated the mobility device platforms described in FIGS. 6-8 are provided merely as illustrative implementations and is not intended to limit the scope of the herein described system and methods. Rather, the herein described systems and methods provide a mobility device platform and/or mobility device that can include but are not limited to the following additional mechanisms and can operate to perform functions and operations including but not limited to: a mobility device operable to interact with a participating user through a directly connected, or embedded physical or virtual display and keyboard; a mobility device operable to connect via a cooperating electronic host environment and/or directly (via a wire or wirelessly) to various environmental and biometric sensors, including but not limited to a fingerprint reader, a DNA sensor, a particulate sensor, a location and orientation sensor, RFID tags, or RFID-enabled SIM cards; a mobility device operable to connect through a cooperating host environment and/or directly to (either via a wire or wirelessly) various input-output devices (e.g. printer, camera) via one or more interfaces, including, but not limited to USB, Firewire, 802.XX (i.e. any of the IEEE 802 communications standards).

In the illustrative implementations, the herein described systems and methods provide a mobility device platform and/or mobility device that can include but are not limited to the following additional mechanisms and can operate to perform functions and operations including but not limited to: a mobility device platform comprising a trusted platform module (TPM) for key management, data integrity management and verification of code segments before execution. This allows for the creation of a contained (firewalled) environment, which is secure against hacking attacks, viruses, and malicious code. This further allows for the management of high-value content. Also he TPM allows for temporary lending of “trust” to a participating user of the mobility device.

Additionally, the herein described systems and methods provide a mobility device platform and/or mobility device that can include but are not limited to the following additional mechanisms and can operate to perform functions and operations including but not limited to: a mobility device comprising a USB to Virtual Device scheme that can be specific to a more general pass-through scheme including a proxy and an active agent. Other examples may include, but not be limited to SD to USB and Ethernet to USB and any generic intermediate processing device that can take action based on various inputs.

Further, the herein described systems and methods provide a mobility device platform and/or mobility device that can include but are not limited to the following additional mechanisms and can operate to perform functions and operations including but not limited to: a mobility device comprising an embedded laser display chip to project a display onto any surface, allowing the display of identity information, digital rights or licensing information; a mobility device that can be configured to allow the enablement, disablement or destruction of RFID tags. In this context, the MD can also be used in a lock-and-key model with an RFID tag such that neither the MD nor the RFID have enough information to complete a particular transaction independent of each other.

Further, the herein described systems and methods provide a mobility device platform and/or mobility device that can include but are not limited to the following additional mechanisms and can operate to perform functions and operations including but not limited to: a mobility device could have the form factor of a mouse device acting as a peripheral to a host environment and other form factors including but not limited to RFID cards, mobile telephones, personal digital assistant, MP3 player, Flash key, credit card, proximity card, pen, wallet, purse, eye-wear, footwear, clothing, under-garments, jewelry, dental appliance, implantable bio-chip, prosthetics, dossier, brief-case, portable telephone, portable facsimile, remote controls, USB device, Ethernet device, SD device, and etc; a mobility device capable of employing separate secure input and/or output devices apart from those coupled to a cooperating electronic host environment; a mobility device operable to utilize an “on-board” trust platform module (TPM) within the MD itself, or to utilize TPMs available in the environment; a mobility device capable of implementing the TPMs (or subsets thereof) in the MD via a dedicated chip, via FPGA or via software emulation; a mobility device comprising one or more FLASH memory slots (e.g., SD, MMC, Memory Stick, XD slots) capable of accepting FLASH memory having various formats; a mobility device comprising various bio-metric sensors including but not limited to, fingerprint sensors(readers), voice recognition sensors, retina pattern recognition or DNA recognition sensors. It should be further recognized that fingerprint or DNA information can be used to generally determine age, which then could be used to set various local, network and environmental permissions. It should be further recognized that the mobility device can be equipped with sensors to scan for biological or chemical agents or markers either within the environment or within the person activating the MPS unit.

Further, the herein described systems and methods provide a mobility device platform and/or mobility device that can include but are not limited to the following additional mechanisms and can operate to perform functions and operations including but not limited to: mobility device utilizing separate batteries (power) for TPM key storage in tamper-resistant volatile memory, for the system clock, for the real-time clock, for the trusted time service, and for the MD system itself; a mobility device platform comprising a network or server-based back-up or “mirror” of an intermittently connected mobility device. It should be further recognized that the mobility device-session can optionally be mirrored from within a networked operating environment, and that mobile desktop environment sessions can be handed off from the mobile desktop environment to the networked operating environment and vice-versa.

Further, the herein described systems and methods provide a mobility device platform and/or mobility device that can include but are not limited to the following additional mechanisms and can operate to perform functions and operations including but not limited to: a mobility device platform capable of employing an X-windows proxy in the mobility device to virtualize desktop and application displays from local cooperating hosts, remote desktops, and those from cooperating MDMS. In the illustrative implementation, the virtualized desktops or application displays can be viewed locally on the mobility device, remotely, rendered within the MDMS, and/or rendered and captured by a selected network service.

Additionally, the herein described systems and methods provide a mobility device platform and/or mobility device that can include but are not limited to the following additional mechanisms and can operate to perform functions and operations including but not limited to: a mobility device comprising one or more processors. In the illustrative implementation, the mobility device hardware can be optionally virtualized and the single or multiple instances of an operating system can operate in parallel such that each of the operating systems and their applications can be isolated from one another.

Further, the herein described systems and methods provide a mobility device platform and/or mobility device that can include but are not limited to the following additional mechanisms and can operate to perform functions and operations including but not limited to: a mobility device operable to add interfaces through expansion slots or natively within the mobility device to support many wireless transport standards, including, but not limited to: Zigbee, GSM, EVDO, Bluetooth, WiFi, RFID, NFC, UWB and wireless USB; a mobility device capable of supporting various extensions or “daughter cards” performing various functions including but not limited to support for additional connectivity, additional computational or storage resources or additional sensors (e.g., microphones, speakers, additional flash storage, cameras, nano-sensors (CO2, biological, chemical, temperature), and clocks or time services).

Further, the herein described systems and methods provide a mobility device platform and/or mobility device that can include but are not limited to the following additional mechanisms and can operate to perform functions and operations including but not limited to: a mobility device platform comprising a mobility device capable of mounting onto a cooperating electronic host environment as a USB type device including but not limited to a USB hub, USB device, USB-Ethernet hub device, and the like using conventional USB mounting processes.

Further, the herein described systems and methods provide a mobility device platform and/or mobility device that can include but are not limited to the following additional mechanisms and can operate to perform functions and operations including but not limited to: a mobility device capable of utilizing an external TPM a wired or wireless interface to a host environment. It should further be recognized that a host environment can utilize a TPM within the mobility device for trust management (as part of a trust model), DRM, access control, secure boot operations and code-segment validation (anti-virus protection and anti-SPAM measures); the MDE can implement policies that require multi-factor authentication and interaction with a server for the authentication process. MDE policies include time-outs, expiry of access rights when not renewed and abuse detection.

Further, the herein described systems and methods provide a mobility device platform and/or mobility device that can include but are not limited to the following additional mechanisms and can operate to perform functions and operations including but not limited to: a mobility device that can operate without a dedicated display, keyboard or mouse, and utilize a cooperating environment's resources for the keyboard, display, mouse and network functionality.

Further, the herein described systems and methods provide a mobility device platform and/or mobility device that can include but are not limited to the following additional mechanisms and can operate to perform functions and operations including but not limited to: a mobility device having connectivity to application services and that utilizes a secure channel to those services that originates from the mobility device to ensure integrity and protection from viruses.

Further, the herein described systems and methods provide a mobility device platform and/or mobility device that can include but are not limited to the following additional mechanisms and can operate to perform functions and operations including but not limited to: a mobility device that automatically synchronizes its state with those of persistently running application services, allowing for backups, data consistency, and long-running application service jobs.

Further, the herein described systems and methods provide a mobility device platform and/or mobility device that can include but are not limited to the following additional mechanisms and can operate to perform functions and operations including but not limited to: a mobility device comprising a browser running from within the mobility device itself and utilizes a cooperating host environment's peripherals such as a keyboard, display and network gateway, allows application developers and publishers to protect DHTML content, and enables strict protection of content licensing rights. In an illustrative implementation, the mobility device can employ a digital rights management (DRM) component in conjunction with the TPM to provide granular license grants to application users, subscription service subscribers, and content viewers.

Further, the herein described systems and methods provide a mobility device platform and/or mobility device that can include but are not limited to the following additional mechanisms and can operate to perform functions and operations including but not limited to: a mobility device comprising a mobile desktop environment that implements a secure administration model, which can be distributed across various cooperating components and which requires no root user. In an illustrative implementation, the model can operate to separate the owner of the mobility device from the user of the mobility device and the manager of the mobility device.

Further, the herein described systems and methods provide a mobility device platform and/or mobility device that can include but are not limited to the following additional mechanisms and can operate to perform functions and operations including but not limited to: a mobility device operating to ensure the state of the users data, content, files, applications and sessions are consistent and that such state information can be migrated from one host to another upon an asynchronous disconnect and re-connect.

Further, the herein described systems and methods provide a mobility device platform and/or mobility device that can include but are not limited to the following additional mechanisms and can operate to perform functions and operations including but not limited to: a mobility device operating capable of determining geographic location information via ad-hoc network protocols (Zigbee), triangulation, or global positioning system (GPS).

Further, the herein described systems and methods provide a mobility device platform and/or mobility device that can include but are not limited to the following additional mechanisms and can operate to perform functions and operations including but not limited to: a mobility device utilizing out-of-band (e.g. radio and other) updates to prevent attackers from changing the mobility device clock and to supplement the network news transfer protocol (NNTP), the secure time protocols and the internal clock. Furthermore, the mobility device can operate to utilize unidirectional transforms (incremental) and hardware “to-expire” dates and countdown counters to prevent reversals in the clock counters.

Further, the herein described systems and methods provide a mobility device platform and/or mobility device that can include but are not limited to the following additional mechanisms and can operate to perform functions and operations including but not limited to: a mobility device comprising an internal “trust vault’ to manage rights, privileges, licenses, subscriptions, session tokens and keys. The mobility device can operate to “project trust” to various environmental devices (e.g. iPod), via mapping rights and keys to the appropriate DRM scheme, and supports degraded playback of content on less secure devices.

Further, the herein described systems and methods provide a mobility device platform and/or mobility device that can include but are not limited to the following additional mechanisms and can operate to perform functions and operations including but not limited to: a mobility device that operate to employ an internal “trust vault”, to manage rights, privileges, licenses, subscriptions, session tokens and keys. In the illustrative implementation, the mobility device can operate to “meld trust” with various external computational devices, so that the content protection capabilities of the mobility device can be utilized by those external devices.

Further, the herein described systems and methods provide a mobility device platform and/or mobility device that can include but are not limited to the following additional mechanisms and can operate to perform functions and operations including but not limited to: a mobility device comprising a mobility device environment utilizing a visual interface using color graphics and/or numbers and size to indicate security, content protection (“DRM”) level, CPU processing resources, storage (capacity and attached bandwidth), and network distance, latency, capacity (bandwidth), availability and scalability.

Further, the herein described systems and methods provide a mobility device platform and/or mobility device that can include but are not limited to the following additional mechanisms and can operate to perform functions and operations including but not limited to: a mobility device operable to utilize a data and computation scattering method, by which network resources can be optimally utilized, and system response times and/or costs can be optimized. In the illustrative implementation, active network agents can be automatically parked, or collapsed whenever some pre-set time period has elapsed, or computational resource budgets have been exceeded. The “autopark” function can be policy-based, and can utilize redundant path optimization methods, including available sensor-node feedback for real-time resource availability feedback.

Further, the herein described systems and methods provide a mobility device platform and/or mobility device that can include but are not limited to the following additional mechanisms and can operate to perform functions and operations including but not limited to: a mobility device operable to utilize the a selected algorithm (e.g., “urinal separation algorithm”) to maximize separation of computational resources used by active network processes.

Further, the herein described systems and methods provide a mobility device platform and/or mobility device that can include but are not limited to the following additional mechanisms and can operate to perform functions and operations including but not limited to: a mobility device comprising a partial fingerprint sensor for fingerprint verification of the user of the mobility device as part of a multi-factor authentication scheme.

Further, the herein described systems and methods provide a mobility device platform and/or mobility device that can include but are not limited to the following additional mechanisms and can operate to perform functions and operations including but not limited to: a mobility device operable to scan the cooperating electronic host environment, determining available computational resources on the cooperating electronic host environment, available devices coupled to or in cooperation with the cooperating electronic host environment, and communication pathways (hotspots).

Further, the herein described systems and methods provide a mobility device platform and/or mobility device that can include but are not limited to the following additional mechanisms and can operate to perform functions and operations including but not limited to: a mobility device platform operable to utilize secure authentication and time and location services, and to implement digital chain of custody tracking. In the illustrative implementation, the mobility device can operate to: a) authenticate the user, b) determine the time and location, c) wrap and stamp a data record with the user ID, the time and data, and optionally the location of the transaction. In the illustrative implementation, this information can be archived and validated at a future date.

Further, the herein described systems and methods provide a mobility device platform and/or mobility device that can include but are not limited to the following additional mechanisms and can operate to perform functions and operations including but not limited to: a mobility device platform operable to utilize the secure authentication, time and location services, to implement private and secure access to medical records or lab results. In the illustrative implementation the mobility device can operate to: a) authenticate the user (doctor), b) determine the time and location, c) determine the authenticity of the output device, d) unwrap and present the requested medical information, e) stamp the medical record access log with the time, data, location and user ID. In the illustrative implementation, this access log information can be archived and validated at a future date.

Further, the herein described systems and methods provide a mobility device platform and/or mobility device that can include but are not limited to the following additional mechanisms and can operate to perform functions and operations including but not limited to: a mobility device platform operable to utilize the secure authentication, time and location services, to implement cooperative yet secure access to medical records or other sensitive information. In the illustrative implementation, the mobility device can operate to: a) authenticate the user (content owner), b) determine the time and location, c) determine the authenticity of the output device, d) unwrap and present the requested sensitive information, and e) stamp the data record access log with the time, data, location and user ID. In the illustrative implementation, this access log information can be archived and validated at a future date.

Further, the herein described systems and methods provide a mobility device platform and/or mobility device that can include but are not limited to the following additional mechanisms and can operate to perform functions and operations including but not limited to: a mobility device platform operable to utilize secure authentication, time and location services, to implement video checksums and watermarking. In the illustrative implementation, the mobility device can operate to: a) authenticate the user (content owner), b) determine the time and location, c) cache the stream of video information, d) stamps the video stream with an embedded (watermark) or associated cryptogram based on the cumulative video data. In the illustrative implementation, the checksum information can be retrieved and validated at a future date.

Further, the herein described systems and methods provide a mobility device platform and/or mobility device that can include but are not limited to the following additional mechanisms and can operate to perform functions and operations including but not limited to: a mobility device platform operable to utilize individual preferences and parameters to customize a participating user's environment. In the illustrative implementation, a mobility device operating in cooperation with an automobile electronic host environment could operate to set/limit maximum speed, collect maintenance information, and recall preferred settings for seat and mirror positions and other parameters. In the illustrative operation, a mobility device operating in cooperation with a home AV system could recall preferred music/video “play-lists”, preferred listening locations, and preferred equalizer settings, among other variables.

Further, the herein described systems and methods provide a mobility device platform and/or mobility device that can include but are not limited to the following additional mechanisms and can operate to perform functions and operations including but not limited to: a mobility device platform operable to utilize the local policy of the mobility device to cache fingerprints on each access attempt, and to dump the fingerprint files to an authority or maintenance server on events as determined by a policy rule set.

Further, the herein described systems and methods provide a mobility device platform and/or mobility device that can include but are not limited to the following additional mechanisms and can operate to perform functions and operations including but not limited to: a mobility device platform operable to utilize the local individual preference and parameters of the mobility device set to maintain IP address and other telephone system parameters to ensure calls coming to a local voice communication console (telephone) are intended for the holder of the mobility device. In the illustrative implementation, the telephone number moves with the mobility device holder and can be projected to a local (desktop or mobile) telephone, along with call lists and stored numbers (contact lists). In the illustrative implementation, the MPS can operate to share display and keypad or other input devices of the external voice communication console. In the illustrative implementation, the MPS can be controlled by voice command through a voice communication console.

Further, the herein described systems and methods provide a mobility device platform and/or mobility device that can include but are not limited to the following additional mechanisms and can operate to perform functions and operations including but not limited to: a mobility device platform operable to utilize media streaming, encoding and decoding capabilities to support secure watermarking of video, pictures and audio.

Further, the herein described systems and methods provide a mobility device platform and/or mobility device that can include but are not limited to the following additional mechanisms and can operate to perform functions and operations including but not limited to: a mobility device operable to utilize available computing resources to enable hardware acceleration of VoIP (Voice over IP) to limit strain on host or environmental devices.

Further, the herein described systems and methods provide a mobility device platform and/or mobility device that can include but are not limited to the following additional mechanisms and can operate to perform functions and operations including but not limited to: a mobility device platform operable to available computing resources to implement software or hardware SDR (software defined radio).

Further, the herein described systems and methods provide a mobility device platform and/or mobility device that can include but are not limited to the following additional mechanisms and can operate to perform functions and operations including but not limited to: a mobility device platform comprising a mobility device operable to utilize available computing resources to implement an MP3 (digital music) player. The player controls can be projected to a display device via IR, wired or wireless interfaces.

Further, the herein described systems and methods provide a mobility device platform and/or mobility device that can include but are not limited to the following additional mechanisms and can operate to perform functions and operations including but not limited to: a mobility device platform operable to utilize trust and DRM capabilities to interact with and grant “trust” to all environmentally local playback devices, based on the capabilities of those devices in the data formats used by those devices.

Further, the herein described systems and methods provide a mobility device platform and/or mobility device that can include but are not limited to the following additional mechanisms and can operate to perform functions and operations including but not limited to: mobility device platform operable to utilize internal personal data, preference and policy management capabilities to implement a “personal domain controller”, allowing the device to collect and aggregate information such as health information. In the illustrative implementation, the mobility device can utilize nano-sensor technology, either embedded or attached, to monitor various medical and environmental variables such as insulin level and heart rate.

Further, the herein described systems and methods provide a mobility device platform and/or mobility device that can include but are not limited to the following additional mechanisms and can operate to perform functions and operations including but not limited to: a mobility device platform comprising one or more mobility devices that can be connected to a high-bandwidth back-plane, such a data-center rack, to enable the one or more mobility devices to be programmed as a single clustered or virtual parallel machine, enabling the creation of low-cost, low-power and compact supercomputers.

Further, the herein described systems and methods provide a mobility device platform and/or mobility device that can include but are not limited to the following additional mechanisms and can operate to perform functions and operations including but not limited to: a mobility device platform operable to utilize multiple CPUs and/or isolated operating system instances to implement firewall and security applications. In the illustrative implementation, the addition of an additional Ethernet interface can enable the implementation of a physical, logical or virtual personal firewall, a personal DMZ, a personal network proxy and a personal network analyzer.

Further, the herein described systems and methods provide a mobility device platform and/or mobility device that can include but are not limited to the following additional mechanisms and can operate to perform functions and operations including but not limited to: a mobility device platform comprising a mobility device having a proximity card or other form-factor that can utilize a local or remote display capability, a fingerprint recognition capability, and a storage capability to satisfy federal government fingerprint and digital identity specifications (e.g., providing two copies of a fingerprint, and two copies of a digital photograph for storage).

Further, the herein described systems and methods provide a mobility device platform and/or mobility device that can include but are not limited to the following additional mechanisms and can operate to perform functions and operations including but not limited to: a mobility device platform operable to be used as a local web or web-service cache, allowing access to information even without host connectivity. In the illustrative implementation, the mobility device cache could be automatically updated according to preferences or manually updated by watching the user's Internet access patterns. In the illustrative implementation, from the host's point-of-view, the mobility device can appear as a remote web-service.

Further, the herein described systems and methods provide a mobility device platform and/or mobility device that can include but are not limited to the following additional mechanisms and can operate to perform functions and operations including but not limited to: a mobility device platform operable to utilize software and secure network access capabilities to enable the anytime ability to delivery software demonstrations to cooperating electronic host environments.

Further, the herein described systems and methods provide a mobility device platform and/or mobility device that can include but are not limited to the following additional mechanisms and can operate to perform functions and operations including but not limited to: a mobility device platform operable to utilize its secure network access capabilities to enable single-sign on and secure data and/or application environment from a cooperating electronic host environment. In the illustrative implementation, the communication sessions can be secured by VPN or SSL-VPN communications managed from within the mobility device.

Further, the herein described systems and methods provide a mobility device platform and/or mobility device that can include but are not limited to the following additional mechanisms and can operate to perform functions and operations including but not limited to: a mobility device platform comprising a mobility device operable to utilize secure network access capabilities and content management capabilities to allow participating users (e.g., students) to carry around their files, records and application access privileges to cooperating electronic host environments (e.g., computers) within an organization (e.g., a school) or enable access to those resources from a remote cooperating computing environment cooperating with the mobility device.

Further, the herein described systems and methods provide a mobility device platform and/or mobility device that can include but are not limited to the following additional mechanisms and can operate to perform functions and operations including but not limited to: a mobility device platform comprising a mobility device operable to utilize secure network access capabilities and content management capabilities to allow customers of financial institutions instant access to any financial service, financial service portal or their own encrypted local financial information (checkbook) from any machine without risk of compromising security or privacy.

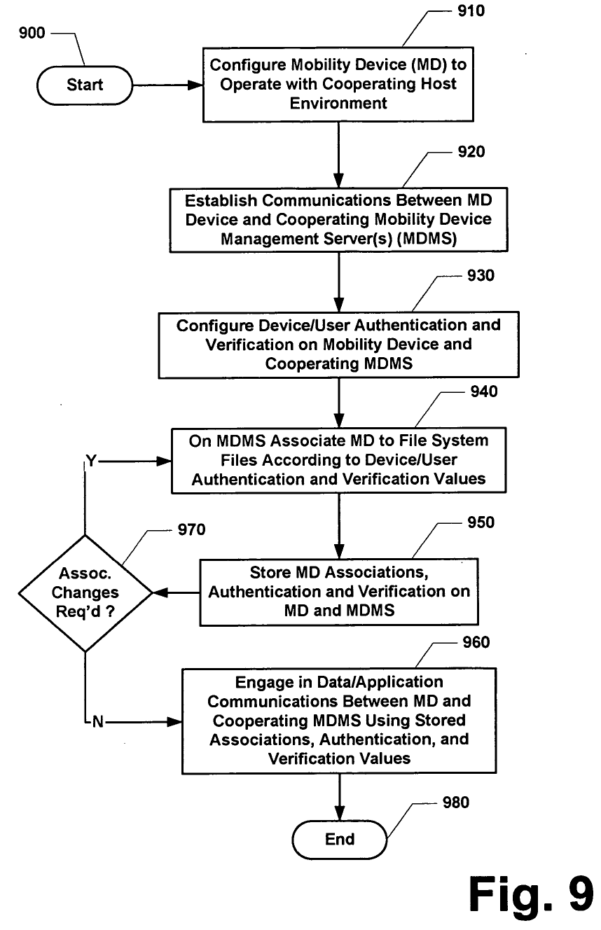

FIG. 9 shoes the processing performed by exemplary mobility device platform 400 of FIG. 4 when configuring the components of exemplary mobility device platform 400 for operation. As is shown in FIG. 9, processing begins at block 900 and proceeds to block 910 where the mobility device is configured to operate with at least one cooperating electronic host environment. In this step (although not shown) exemplary mobility device platform can initiate communications with at least one cooperating electronic host environment through a selected communications interface operating a selected communications interface protocol. Once communications are established, exemplary mobility device platform can instruct the mobility device to execute one or more executables for display and navigation on a connected cooperating electronic host environment. Included in the mobility device executables can be a mobile desktop computing environment. From block 910, processing proceeds to block 920 where communications are established between the MD and cooperating MDMS over an exemplary communications network (not shown) operating on a exemplary communications network protocol (not shown). Once the communications are established between the MD and the MDMS, the MD and MDMS user/device authentication and verification values are created and stored for subsequent use at block 930. Using these authentication and verification values, the MDMS is capable of associating file system file and group settings at block 940. The file and group associations, and authentication and verification values are stored for subsequent use at block 950. A check is then performed at block 960 to determine if an association in files or groups is required for the MD on the MDMS. If the check at block 960 indicates a change in the MD file and/or group associations, processing reverts to block 940 and proceeds there from.

However, if at block 960 it is determined that there are no MD file and/or group association settings to be made, processing proceeds to block 970 where data and/or computing application communications between the MD and MDMS are performed using the generated and stored MD and user authentication and verifications values. Processing then terminates at block 980.

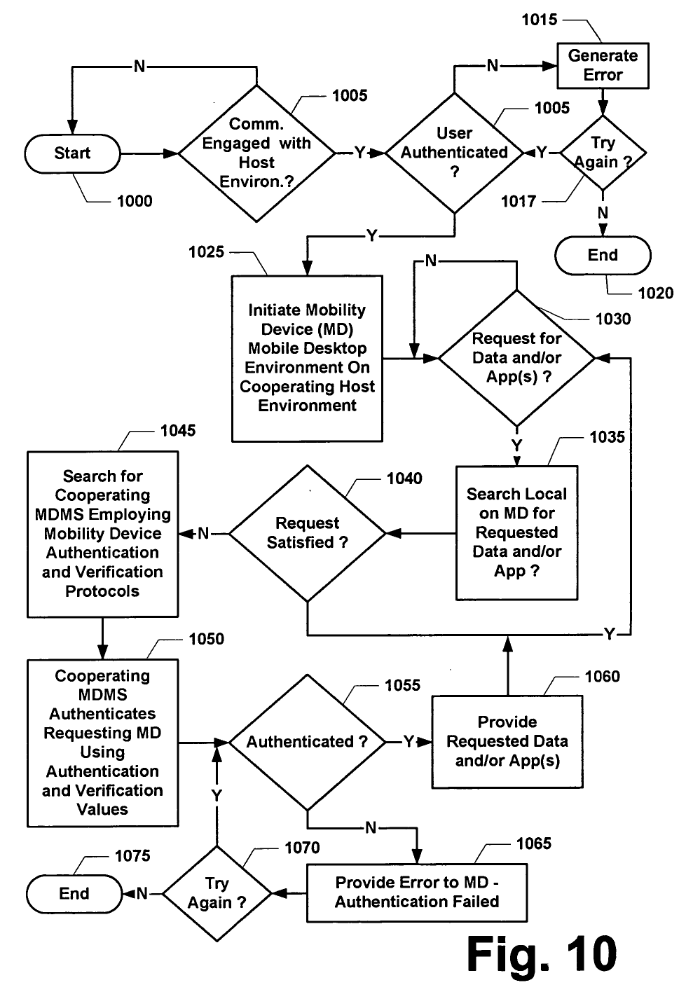

FIG. 10 shows processing performed by exemplary mobility device platform 400 of FIG. 4 when processing web services requests from cooperating exemplary mobility device 405 of FIG. 4 according to an illustrative implementation. As is shown in FIG. 10, processing begins at block 1000 and proceeds to block 1005 where a check is performed to ensure that exemplary mobile device 405 is in communication with at least one cooperating electronic host environment (415 of FIG. 4). If the check at block 1005 indicates that exemplary mobility device is not in communication with at least one cooperating electronic host environment, processing reverts to block 1000 and proceeds from there.

However, if at block 1005 it is determined that exemplary mobility device 405 is in communication with at least one cooperating electronic host environment, processing proceeds to block 1010 where a check is performed to determine if the mobility device has been authenticated on a user basis (e.g. if the proper user identification and password information provided by a participating user). If the mobility device has not been successfully authenticated on a user basis, processing proceeds to block 1015 where an error is generated (and possibly displayable to participating users). From there a check is performed at block 717 to determine if the user authentication of the mobility device is to be attempted again (i.e. a participating user is afforded the ability to re-input their user identification and password). If the authentication is being performed again at block 1017, processing reverts back to block 1010 and proceeds there from. However, if at block 1017 it is determined that the user authentication is not to be attempted again, processing terminates at block 1020.

If, however, at block 1010 it is determined that the mobility device is authenticated on a user basis, processing proceeds to block 1025 where the mobility device mobile desktop environment is initiated on the at least one cooperating electronic host environment. From there processing proceeds to block 1030 where a check is performed to determine if there are any requests for data and/or computing applications by the MD to at least one cooperating MDMS that has authenticated the MD. If the check at block 1030 indicates that there are no requests by the authenticated MD, processing reverts back to the input of block 1030.

However, if at block 1030, it is determined that there has been a request for data and/or computing applications by the MD, processing proceeds to block 1035 where the MD is searched locally for the requested data and/or computing application. A check is then performed at block 1040 to determine if the request was satisfied by the local search of the MD. If the check at block 1040 indicates that the request has been satisfied by the local search of the MD, processing reverts to the input of block 1030 and proceeds from there.

If, however, the check at block 1040 indicates that the request has not been satisfied, processing proceeds to block 1045 where cooperating MDMS are searched for using the user authentication information provided at block 1010. From there, cooperating MDMS that are capable of authenticating the seeking MD proceed to authenticate the MD using the user authentication information. A check is then performed at block 1055 to determine if the MD was authenticated on an MD basis using the user authentication information. If the check at block 1055 indicates that the MD has been authenticated by the MDMS, processing proceeds to block 1060 where the MDMS provides the requested data and/or computing applications to the requesting, now authenticated, MD. From there processing reverts to the input of block 1030 and proceeds from there.

If, however, at block 1055 it is determined that the cooperating MDMS did not authenticate the requesting MD, processing proceeds to block 1065 where the error in authentication is provided to the requesting MD. From there processing proceeds to block 1070 where a check is performed to determine whether to try authenticating the MD again by the cooperating MDMS. If the check at block 1070 indicates that authentication is to be attempted again, processing reverts to the input of block 1055 and proceeds from there.

However, if at block 1070 it is determined that authentication is not to be attempted again by the MDMS, processing proceeds to block 1075 and terminates.

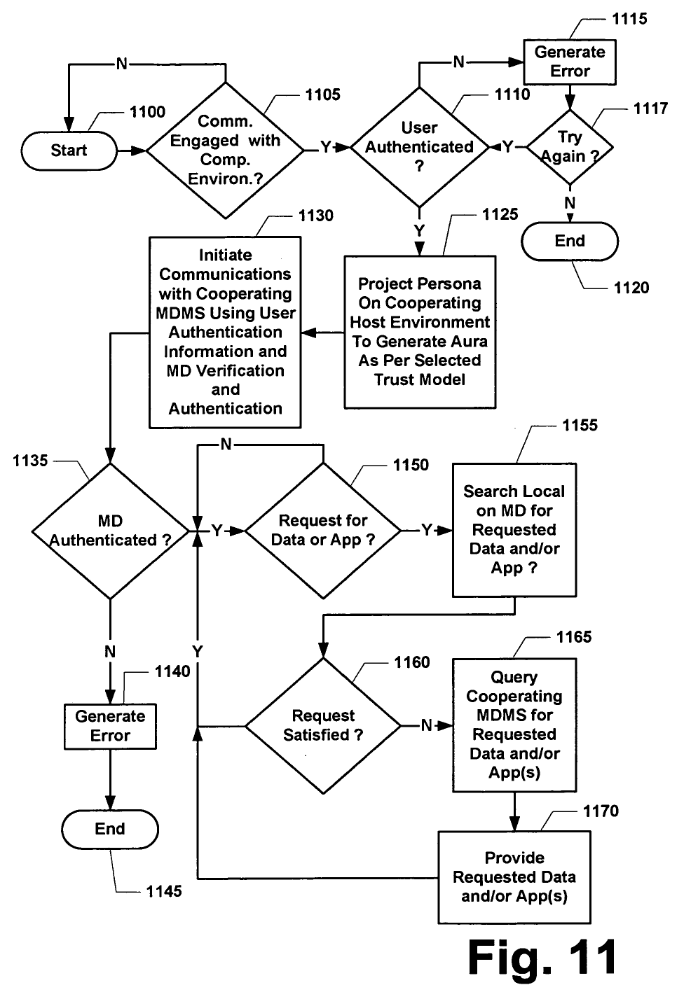

FIG. 11 shows processing performed by exemplary mobility device platform 400 of FIG. 4 when processing data/applications requests from cooperating exemplary mobility device 405 of FIG. 4 according to another illustrative implementation. As is shown in FIG. 11, processing begins at block 1100 and proceeds to block 1105 where a check is performed to ensure that exemplary mobile device 405 is in communication with at least one cooperating electronic host environment (415 of FIG. 4). If the check at block 1105 indicates that exemplary mobility device is not in communication with at least one cooperating computing environment, processing reverts to block 1100 and proceeds from there.

However, if at block 1105 it is determined that exemplary mobility device 405 is in communication with at least one cooperating electronic host environment, processing proceeds to block 1110 where a check is performed to determine if the mobility device has been authenticated on a user basis (e.g. if the proper user identification and password information provided by a participating user). If the mobility device has not been successfully authenticated on a user basis, processing proceeds to block 1115 where an error is generated (and possibly displayable to participating users). From there a check is performed at block 1117 to determine if the user authentication of the mobility device is to be attempted again (i.e. a participating user is afforded the ability to re-input their user identification and password). If the authentication is be performed again at block 1117, processing reverts back to block 1110 and proceeds there from. However, if at block 1117 it is determined that the user authentication is not to be attempted again, processing terminates at block 1120.

If, however, at block 1110 it is determined that the mobility device is authenticated on a user basis, processing proceeds to block 1125 where the mobility device mobile desktop environment is initiated on the at least one cooperating computing environment. From there, communications are initiated with at least one cooperating MDMS using the user authentication information and MD specific authentication and verification information (e.g. public/private keys). A check is then performed at block 1135 to determine if at least one cooperating MDMS has properly authenticated the MD. If at block 1135 it is determined that the MD has not been authenticated by at least one cooperating MDMS, processing proceeds to block 1140 where an error is generated (and possibly displayable to participating users through the mobile desktop environment). From there processing terminates at block 1145.

However, if at block 1135 it is determined that at least one cooperating MDMS has authenticated the mobility device, processing proceeds to block 1150 where a check is performed to determine if there are any requests for data and/or computing applications by the MD to at least one cooperating MDMS that has authenticated the MD. If the check at block 1150 indicates that there are no requests by the authenticated MD, processing reverts back to the input of block 1150.

However, if at block 1150, it is determined that there has been a request for data and/or computing applications by an authenticated MD to at least one cooperating MDMS that has authenticated the MD, processing proceeds to block 1155 where the MD is searched locally for the requested data and/or computing application. A check is then performed at block 1160 to determine if the request was satisfied by the local search of the MD. If the check at block 1160 indicates that the request has been satisfied by the local search of the MD, processing reverts to the input of block 1150 and proceeds from there.

If, however, the check at block 1160 indicates that the request has not been satisfied, processing proceeds to block 865 where the cooperating MDMS are queried for the requested data and/or computing applications. The requested data and/or computing applications are then provided to the requesting authenticated MD at block 1170. From there processing reverts to the input of block 1150 and proceeds there from.

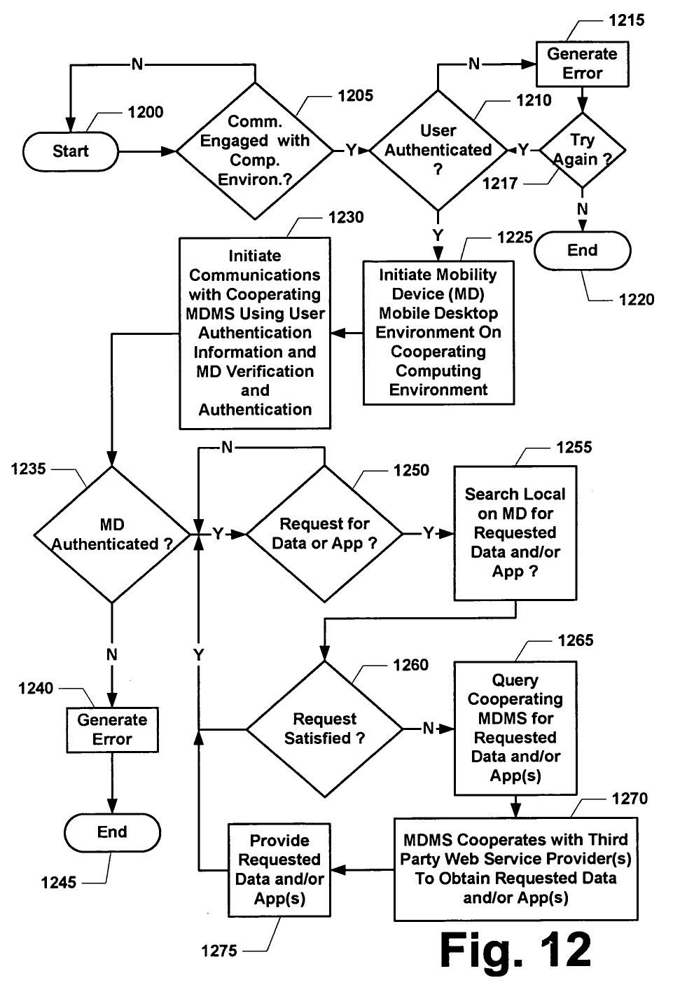

FIG. 12 shows the processing performed by exemplary mobility device platform 400 of FIG. 4 when cooperating with third party data/application providers to process data/application requests from cooperating exemplary mobility device 405 of FIG. 4. As is shown in FIG. 12, processing begins at block 1200 and proceeds to block 1205 where a check is performed to ensure that exemplary mobile device 405 is in communication with at least one cooperating electronic host environment (415 of FIG. 4). If the check at block 1205 indicates that exemplary mobility device is not in communication with at least one cooperating computing environment, processing reverts to block 1200 and proceeds from there.

However, if at block 1205 it is determined that exemplary mobility device 1205 is in communication with at least one cooperating computing environment, processing proceeds to block 1210 where a check is performed to determine if the mobility device has been authenticated on a user basis (e.g. if the proper user identification and password information provided by a participating user). If the mobility device has not been successfully authenticated on a user basis, processing proceeds to block 1215 where an error is generated (and possibly displayable to participating users). From there a check is performed at block 1217 to determine if the user authentication of the mobility device is to be attempted again (i.e. a participating user is afforded the ability to re-input their user identification and password). If the authentication is be performed again at block 1217, processing reverts back to block 1210 and proceeds there from. However, if at block 1217 it is determined that the user authentication is not to be attempted again, processing terminates at block 1220.

If, however, at block 1210 it is determined that the mobility device is authenticated on a user basis, processing proceeds to block 1225 where the mobility device mobile desktop environment is initiated on the at least one cooperating computing environment. From there, communications are initiated with at least one cooperating MDMS using the user authentication information and MD specific authentication and verification information (e.g. public/private keys). A check is then performed at block 1235 to determine if at least one cooperating MDMS has properly authenticated the MD. If at block 1235 it is determined that the MD has not been authenticated by at least one cooperating MDMS, processing proceeds to block 1240 where an error is generated (and possibly displayable to participating users through the mobile desktop environment). From there processing terminates at block 1245.

However, if at block 1235 it is determined that at least one cooperating MDMS has authenticated the mobility device, processing proceeds to block 1250 where a check is performed to determine if there are any requests for data and/or computing applications by the MD to at least one cooperating MDMS that has authenticated the MD. If the check at block 950 indicates that there are no requests by the authenticated MD, processing reverts back to the input of block 1250.

However, if at block 1250, it is determined that there has been a request for data and/or computing applications by an authenticated MD to at least one cooperating MDMS that has authenticated the MD, processing proceeds to block 1255 where the MD is searched locally for the requested data and/or computing application. A check is then performed at block 1260 to determine if the request was satisfied by the local search of the MD. If the check at block 1260 indicates that the request has been satisfied by the local search of the MD, processing reverts to the input of block 1250 and proceeds from there.

If, however, the check at block 1260 indicates that the request has not been satisfied, processing proceeds to block 1265 where the cooperating MDMS are queried for the requested data and/or computing applications. From there, processing proceeds to block 1270 where the cooperating MDMS cooperates with third party data/application providers to obtain the requested data and/or computing applications. The requested data and/or computing applications are then provided to the requesting authenticated MD at block 1275. From there processing reverts to the input of block 1250 and proceeds there from.

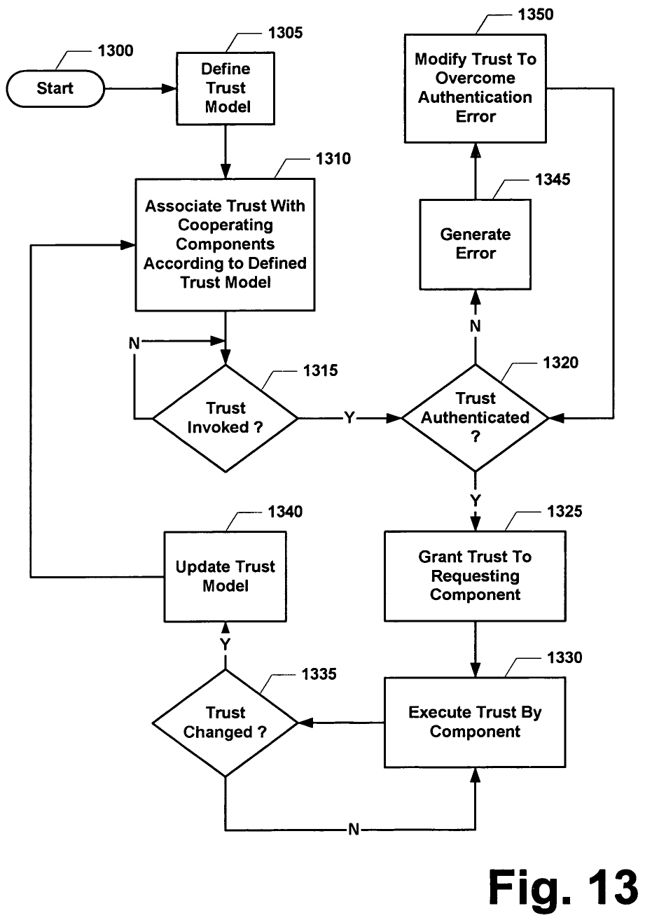

FIG. 13 shows the processing performed when deploying a trust model as employed by an exemplary mobility device platform. As is shown in FIG. 13, processing begins at block 1400 and proceeds to block 1305 where a trust model is defined. From there processing proceeds to block 1320 where trust is associated with cooperating components of a mobility device platform (not shown) according to the defined trust model. In an illustrative implementation, trust can be considered authentication and verification of a device to perform on or more operations/functions according to selected criteria. A check is then performed at block 1315 to determine if the trust has been invoked by one or more of the cooperating components having trust. If the check at block 1315 indicates that trust has not been invoked, processing reverts to the input of block 1315 and proceeds from there.

However, if at block 1315, it is determined that trust has been invoked, processing proceeds to block 1320 where a check is performed to determine if the trust has been authenticated against the defined trust model. If the check at block 1320 indicates that the trust has not been authenticated, processing proceeds to block 1345 where an error is generate. From there, the trust can be modified at block 1350 to overcome the authentication error. Processing then reverts back to block 1320 and proceeds from there.

However, if at block 1320 it is determined that the trust has been authenticated, processing proceeds to block 1325 to grant trust to requesting component. From there processing proceeds to block 1330 where the trust is executed by the component. In an illustrative implementation, a mobility device can request trust to display protected content on a cooperating electronic host environment. The trust can be authenticated to ensure that the requesting mobility device has the adequate privileges, rights, and licenses to display the protect content (e.g., trust) according to selected trust model. If the trust is authenticated, the trust can be executed (e.g., the content can be displayed by the mobility device on the cooperating electronic host environment) by the requesting component (e.g., mobility device).

A check is then performed at block 1335 to determine if the trust has changed. If the check at block 1335 indicates that the trust has not changed, processing reverts back to block 1330 and proceeds from there. However, if at block 1335 it is determined that the trust has changed (e.g., license to protected content has expired), processing proceeds to block 1340 where the trust model is updated. From there processing proceeds to block 1310 and continues from there.

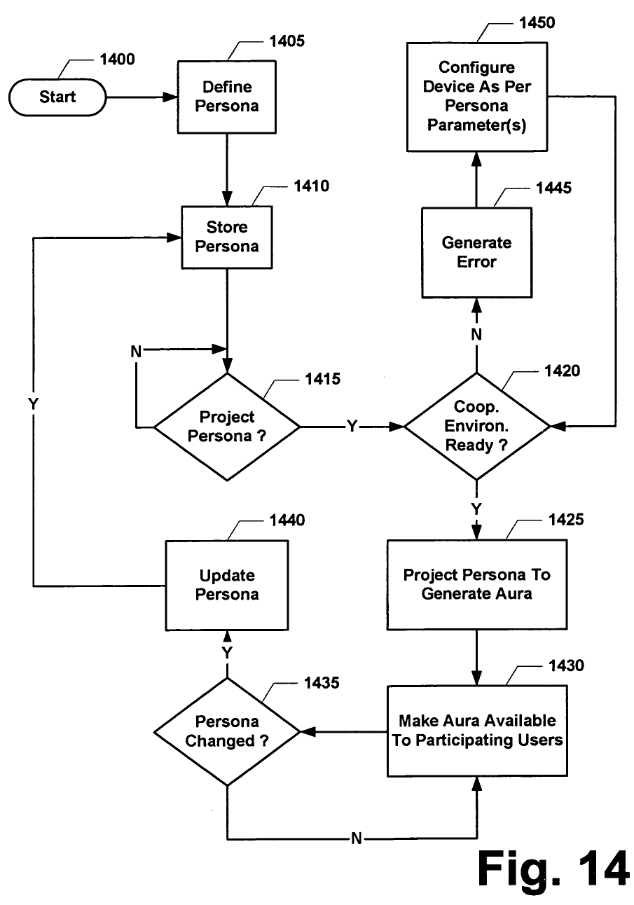

FIG. 14 shows the processing performed when generating and projecting a persona to generate an aura for as deployed by an exemplary mobility device platform. As is shown, processing begins at block 1400 and proceeds to block 1405 a persona is defined. In an illustrative implementation, a persona can be considered custom preferences, privileges, rights (content and access), and authentications available to users and to mobility devices for use as part of a trust model and for use in projecting the persona as an aura on a cooperating electronic host environment. From block 1405, processing proceeds to block 1410 where the persona is stored (e.g., stored on a cooperating mobility device and/or mobility device management server). A check is then performed at block 1415 to determine whether to project the persona on a cooperating electronic host environment. If the check at block 1415 indicates that the persona is not to be projected, processing proceeds to the input of block 1415 and continues from there.

However, if the check at block 1415 indicates that a persona is to be projected, processing proceeds to block 1420 where a check is performed to determine if the cooperating environment accepting the persona is ready to receive the persona. If the check at block 1420 indicates that the cooperating environment is not ready to receive the persona, processing proceeds to block 1445 where an error is generated. From there, the cooperating environment can be configured as per the persona parameters. Processing reverts back to block 1420 and proceeds from there.

However, if at block 1420, it is determined that the cooperating environment is ready to accept a projected persona, processing proceeds to block 1425 where the persona is projected to the ready cooperating environment to generate an aura on the cooperating environment. In an illustrative implementation, an aura can be considered a projected persona (in whole or in part). From there processing proceeds to block 1430 where the aura is made available to participating users of the cooperating environment. A check is then performed at block 1435 to determine if the persona and/or persona parameters have changed. If the check at block 1435 indicates that the persona has not changed, processing reverts back to block 1430 and proceeds from there. However, if at block 1435 the check indicates that the persona has changed, processing proceeds to block 1440 where the persona is updated. From there, processing reverts back to block 1410 and proceeds from there.

The herein described systems and methods provide a mobility device platform. It is understood, however, that the herein described systems and methods are susceptible to various modifications and alternative constructions. There is no intention to limit the herein described systems and methods to the specific constructions described herein. On the contrary, the herein described systems and methods is intended to cover all modifications, alternative constructions, and equivalents falling within the scope and spirit of the herein described systems and methods.

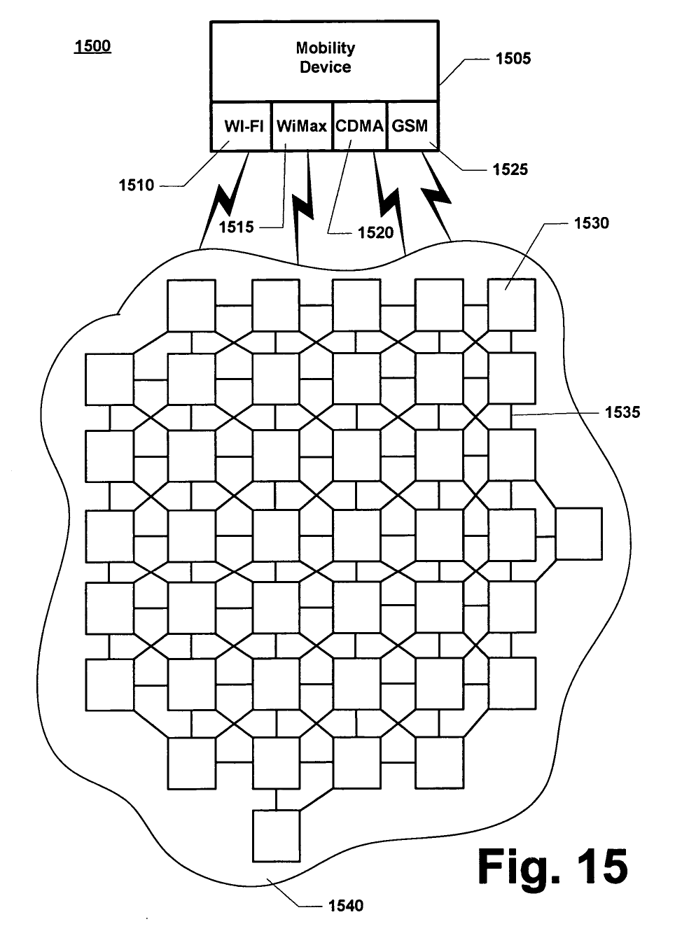

FIG. 15 shows a block diagram of an illustrative implementation of the deployment of an exemplary mobility device platform in a municipal data communications grid environment 1500. As is shown in FIG. 15, municipal data communications grid environment 1500 comprises municipal data communications grid 1540 and mobility device 1505. In an illustrative implementation mobility device 1505 comprises a plurality of wireless and wired transceivers operating on various wireless and wired communication protocols. In the illustrative implementation, mobility device 1505 comprises a plurality of wireless transceivers including but not limited to: WI-FI wireless transceiver 1510, WiMax wireless transceiver 1515, CDMA wireless transceiver 1520, and GSM wireless transceiver 1325. Additionally, as is shown in FIG. 15, municipal data communication grid 1540 comprises a plurality of wireless (or wired) data communication cells interconnected across a geographic area by electronic interconnects 1535.

In an illustrative operation, municipal data communications grid 1540 can operate to electronically (wirelessly and non-wirelessly) communicate data between data communications cells 1530 and with cooperating devices such as mobility device 1505. In the illustrative implementation, municipal data communications grid can comprise of a homogenous data communication cell architecture or a non-homogenous data communication cell architecture. In the context of a homogenous data communications cell architecture, mobility device 1505, in an illustrative operation, can cooperate with municipal data communications grid using one of the plurality of transceivers (e.g., if the municipal data communications grid 1540 comprises WiMax data communication cells operating on the WiMax (i.e., 802.16) wireless communications protocol, mobility device 1505 can select the WiMax wireless transceiver to communicate data over such a municipal data communication grid). In the context of a municipal data communications grid having a non-homogenous data communications cell architecture, mobility device 1305, in another illustrative operation can operate to perform transceiver selection (i.e., select a transceiver for communication of data) based on the location of mobility device 1505 within municipal data communications grid 1540.

That is, if mobility device 1505 is in a geographic area within municipal data communications grid 1540 having CDMA data communications cells, mobility device 1505 can select the CDMA transceiver to wirelessly communicate data across that part of municipal data communications grid 1540. Subsequently, if mobility device 1505 moves geographically (e.g., commuting from school which is located in a CDMA data communications cell region of the municipal data communications grid to home which is a WI-FI data communications cell region of the municipal data communications grid) to another portion of the municipal data communications grid operating data communications cells using a WI-FI communications protocol, mobility device 1505 can change the selection of the transceiver from the CDMA transceiver 1520 to the WI-FL transceiver 1510. In the illustrative implementation, mobility device 1505 can have the form factor of a mobile telephone having multiple transceivers and selecting the appropriate transceiver depending on available data communication protocols. In an illustrative operation, mobility device 1505 can operate to connect to an exemplary data communications grid (wirelessly or non-wirelessly) such that data and voice communications can be realized regardless of the available data communications protocol.

It should also be noted that the present herein described systems and methods can be implemented in a variety of computer environments (including both non-wireless and wireless computer environments), partial computing environments, and real world environments. The various techniques described herein may be implemented in hardware or software, or a combination of both. Preferably, the techniques are implemented in computing environments maintaining programmable computers that include a processor, a storage medium readable by the processor (including volatile and non-volatile memory and/or storage elements), at least one input device, and at least one output device. Computing hardware logic cooperating with various instructions sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

Although an exemplary implementation of the herein described systems and methods have been described in detail above, those skilled in the art will readily appreciate that many additional modifications are possible in the exemplary embodiments without materially departing from the novel teachings and advantages of the herein described systems and methods. Accordingly, these and all such modifications are intended to be included within the scope of the herein described systems and methods. The herein described systems and methods can be better defined by the following exemplary claims.

What is claimed is:

1. A mobility device platform comprising:
a mobility device having independent computing capabilities operable to interface with a host environment such that the mobility device is operable to control the host environment; and
a mobility device management server cooperating with the mobility device to provide data to the mobility device.

2. The platform as recited in claim 1 further comprising a communications network operative to communicate data between the mobility device and the mobility device management server.

3. The platform as recited in claim 1 further comprising a trust model.

4. The platform as recited in claim 3 wherein the trust model comprises at least one instruction set to instruct the mobility device to cooperate with the host computer according to one or more selected security parameters.

5. The platform as recited in claim 3 wherein the trust model comprises at least one instruction set to instruct the mobility device management server to cooperate with the mobility device according to one more selected parameters comprising, security parameters, authentication parameters, verification parameters, data communication encryption/decryption parameters, virtual private network (VPN) parameters, and authorization parameters.

6. The platform as recited in claim 5 wherein the trust model comprises a portion of the mobility device management server.

7. The platform as recited in claim 6 wherein the trust model comprises a portion of an administration application executing on the mobility device management server.

8. The platform as recited in claim 1 further comprising a communications interface operative to connect the mobility device with the host environment.

9. The platform as recited in claim 8 wherein the communications interface is embedded in the mobility device.

10. The platform as recited in claim 8 wherein the communications interface comprises any of universal serial bus (USB), IEEE 1394 communications interface (Firewire), 802.XX communications interface, blutetooth communications interface, personal computer interface, small computer serial interface, powered Ethernet, and wireless application protocol (WAP) communications interface.

11. The platform as recited in claim 10 wherein the host environment comprises any of a stand alone computing environment, a networked computer environment, an apparatus having computing capability, and an embedded computing environment.

12. The platform as recited in claim 1 wherein in the mobility device further comprises one or more mobile desktop environments operable to provide control over one or more mobility device functions.

13. The platform as recited in claim 12 wherein the one or more mobile desktop environments are displayable on the host environment.

14. The platform as recited in claim 12 wherein the mobility device cooperates with host environment to display the mobile desktop environment operative to receive and process commands inputted through one or more peripherals coupled to the host environment to control, manipulate, and manage data and applications provided by the mobility device.

15. The platform as recited in claim 12 wherein the mobility device supports unique authentication and verification for each of the one or more mobility desktop environments.

16. The platform as recited in claim 1 wherein the mobility device management server cooperates with other mobility management device servers to provide data and/or applications to the mobility device.

17. The platform as recited in claim 16 wherein the mobility device management server provides web services to the mobility device.

18. A method for communicating data comprising:
providing a mobility device having independent computing capabilities operable to interface with a host; and
providing a mobility device management server cooperating with the mobility device to provide data to the mobility device.

19. The method as recited in claim 18 further comprising establishing a communications link between the mobility device and the host environment.

20. The method as recited in claim 19 further comprising establishing a communications link between the mobility device and the mobility device management server.

21. The method as recited in claim 20 further comprising executing a trust model.

22. The method as recited in claim 21 further comprising receiving a request for data from the mobility device to the mobility device management server.

23. The method as recited in claim 21 further comprising receiving a request for a web service from the mobility device to the mobility device management server using server object access protocol (SOAP).

24. A mobile computing environment platform comprising:
a first means for interfacing with a cooperating computing environment, the first means having independent computing capabilities; and
a second means for providing data and/or applications to the first means according to a selected trust model.

25. The platform as recited in claim 24 further comprising a third means for operatively linking the first and second means together.

26. A method to remotely obtain secure data comprising:
configuring a mobility device with a cooperating computing environment such that the mobility device is operable to execute one or more computing applications on the cooperating computing environment;
establishing communications with at least one cooperating mobility device management server;
authenticating at the mobility device management server the mobility device to determine the rights, access, and privileges of the mobility device to access data on the mobility device management server;
receiving requests for data from the mobility device at the mobility device management server;
processing the requests for data using the mobility device authentication information;
retrieving data to satisfy data requests by the mobility device;
encrypting the data according to a selected encryption protocol; and
communicating the requested data to the mobility device for use on the cooperating computing environment.

27. The method as recited in claim 26 further comprising performing an auto-run of at least one application or routine found on the mobility device when configuring the mobility device with the cooperating computing environment.

28. The method as recited in claim 26 further comprising retrieving bio-metric information from the mobility device as part of the authenticating step.

29. The method as recited in claim 26 further comprising presenting a graphical user interface on the cooperating computing environment, the graphical user interface being part of an X-WINDOWS presentation paradigm.

30. The method as recited in claim 26 further comprising executing one or more JAVA virtual machines on the mobility device to facilitate cooperation between the mobility device and the cooperating computing environment.

31. A mobile device platform comprising:
a mobility device having independent computing capability operable to mount onto a host environment; and
a mobility device management server cooperating with the mobility device to provide data and/or applications to the mobility device according to a selected trust model.

32. The platform as recited in claim 31 wherein the mobility device is operable to interact with a participating user through one or more peripherals comprising a display connected to the host environment, a keyboard directly connected to the host environment, an embedded display on the mobility device, an embedded keyboard on the mobility device, a virtual display, and a virtual keyboard.

33. The platform as recited in claim 31 wherein the mobility device comprises one or more sensors comprising environmental sensors and bio-metric sensors.

34. The platform as recited in claim 33 wherein the environmental sensors comprise a particulate sensor, a location sensor, and orientation sensor.

35. The platform as recited in claim 34 wherein the environmental sensors comprise RFID tags and RFID-enabled SIM cards.

36. The platform as recited in claim 33 wherein the bio-metric sensors comprise a fingerprint reader and DNA sensors.

37. The platform as recited in claim 36 wherein the environmental sensors comprise RFID tags and RFID-enabled SIM cards.

38. The platform as recited in claim 31 further comprising a Trusted Platform Module operable to perform key management and ensure data integrity management and verification of code segments prior to code segment execution.

39. The platform as recited in claim 38 wherein the mobility device lends trust to a participating user according to a selected trust model.

40. The platform as recited in claim 31 wherein the mobility device cooperates with the host environment according to a selected pass-through scheme.

41. The platform as recited in claim 40 wherein the selected pass-through scheme comprises USB to virtual device pass-through scheme, smart device to USB pass-through scheme, Ethernet to USB pass-through device, and generic processing device to USB pass-through scheme.

42. A method to communicate data comprising:
providing a mobility device having an independent computing capability that is mountable on a host environment according to a selected device/host mounting protocol; and
providing a mobility device management server operable to communicate data and/or applications to the mobility device according to a selected trust model.

43. The method as recited in claim 42 further comprising providing a migratory display server capable of providing processing snapshots and logging operations that can be injected onto the host environment.

44. The method as recited in claim 42 further comprising configuring the mobility device to mount to the host environment utilizing a selected pass-through device driver protocol.

45. The method as recited in claim 44 further comprising configuring the mobility device to mount to the host environment by presenting the mobility device through a USB/CD-ROM startup procedure employed by the host environment to present the mobility device as a CD-ROM device to the host environment.

46. The method as recited in claim 45 further comprising reading data from one or more files on the host environment to generate an IP address for the mobility device.

47. The method as recited in claim 46 further comprising un-mounting the mobility device as a CD-ROM device and remounting it as a network interface card (NIC) upon reading the generated IP address from the host environment by the mobility device.

48. The method as recited in claim 42 further comprising presenting the mobility device to the host environment as a flash drive having an input file and an output file.

49. The method as recited in claim 42 further comprising providing the mobility device operable to process, store, collect, retrieve, and/or manage forensic evidence.

50. The method as recited in claim 42 further comprising providing the mobility device employing a selected parasitic power protocol.

51. The method as recited in claim 42 further comprising providing the mobility device employing a redundant power protocol.

52. The method as recited in claim 42 further comprising securely booting an operating system found on the mobility device.

53. The method as recited in claim 52 further comprising loading trusted software code segments from the mobility device to a cooperating host environment.

54. The method as recited in claim 53 further comprising executing the loaded trusted software code segments on the cooperating host environment.

55. The method as recited in claim 42 further comprising booting the mobility device within the host environment.

56. The method as recited in claim 55 further comprising providing parasitic injection of the host environment and/or the mobility device management server by the mobility device.

57. The method as recited in claim 42 further providing infrastructure services by the mobility device management server to the mobility device comprising security, confidentiality, integrity, authentication, authorization, identity, identity attributes, subscription management, billing/account management, license management, and content management.

58. The method as recited in claim 42 further comprising separating license grants from bundles of content by the mobility device management server as part of selected content distribution and licensing model.

59. The method as recited in claim 45 further comprising separating license grants from bundles of content by the mobility device management server as part of selected content distribution and licensing model.

60. The method as recited in claim 42 further comprising providing one or more personas on the mobility device.

61. The method as recited in claim 60 further comprising separating the one or more personas by the mobility device and/or mobility device management server responsive to how the mobility device is being used on the host environment.

62. The method as recited in claim 61 further comprising hosting the associated keys, profiles, files, and content for the one or more personas by the mobility device in an secure storage area.

63. The method as recited in claim 42 further comprising injecting a BIOS by the mobility device onto the host environment.

64. The method as recited in claim 42 further comprising injecting a virtual machine into the host environment.

65. The method as recited in claim 64 further comprising executing one or more applications on the injected virtual machine.

66. The method as recited in claim 65 further comprising performing license borrowing when executing the one or more applications on the injected virtual machine by the mobility device.

67. The method as recited in claim 42 further comprising recognizing and registering active devices and computing resources found on the mobility device on the host environment by the mobility device.

68. The method as recited in claim 42 further comprising receiving data and/or processing instructions from one or more peripherals connected to the host environment by the mobility device.

69. The method as recited in claim 42 further comprising outputting data and/or processing instructions to one or more peripherals connected the host environment.

70. The method as recited in claim 42 further comprising providing driver abstraction for one or more cooperating input/output peripherals cooperating with the host environment by the mobility device.

71. The method as recited in claim 42 further comprising providing driverless installation for one or more cooperating input/output peripherals cooperating with the host environment by the mobility device.

72. The method as recited in claim 42 further comprising preventing the changing of the system clock of the mobility device by the mobility device.

73. The method as recited in claim 42 further comprising preventing the disabling of synchronization of the mobility device with a secure system clock by the mobility device.

74. The method as recited in claim 42 further comprising separating roles, rights, and/or privileges of the mobility device to identify and employ roles, rights, and/or privileges belonging to one or more of the owner of the mobility device, the user of the mobility device, and an administrator for the mobility device.

75. The method as recited in claim 42 further comprising importing identity data from cooperating flash type memory by the mobility device.

76. The method as recited in claim 42 further comprising checking the state of the host environment by the mobility device.

77. The method as recited in claim 42 further comprising diagnosing the host environment by the mobility device.

78. The method as recited in claim 42 further comprising repairing the host environment by the mobility device.

79. The method as recited in claim 42 further comprising disabling the host environment by the mobility device.

80. The method as recited in claim 42 further comprising performing a back-up of data and/or applications found on the host environment by the mobility device.

81. The method as recited in claim 42 further comprising performing one or more security operations to secure the host environment by the mobility device.

82. The method as recited in claim 42 further comprising copying files to the host environment from the mobility device.

83. The method as recited in claim 42 further comprising copying files from the host environment to the mobility device.

84. The method as recited in claim 42 further comprising embedding an RFID capability in the mobility device so the mobility device can act as a smart document.

85. The method as recited in claim 84 further comprising providing a bio-metric sensor on the mobility device for use as part of a user authentication protocol.

86. The method as recited in claim 85 further comprising presenting the mobility device as a smart passport having one or more authentication mechanisms comprising RFID authentication and bio-metric authentication.

87. The method as recited in claim 84 further comprising tracking the mobility device through the RFID capability.

88. The method as recited in claim 42 further comprising communicating data between cooperating one or more mobility devices and one or more mobility device management servers based on a selected authorization paradigm.

89. The method as recited in claim 42 further comprising providing trust to other cooperating components cooperating with the mobility device according to a selected trust model.

90. The method as recited in claim 89 further comprising providing a trust model based on content policies/rights and/or profile descriptions of the cooperating components.

91. The method as recited in claim 90 further comprising delivering content to the cooperating components in various degrees of quality based on the selected trust model.

92. The method as recited in claim 89 further comprising allowing the cooperating components to utilize content protection capabilities found on the mobility device.

93. The method as recited in claim 42 further comprising automatically optimizing the distribution and allocation of data and/or computational resources for a process being performed by a host environment comprising a networked computing environment.

94. The method as recited in claim 42 further comprising allowing for the manual management of the distribution and allocation of data and/or computational resources for a process being performed by a host environment comprising a networked computing environment.

95. The method as recited in claim 42 further comprising providing multi-factor authentication of a participating user of the mobility device on the mobility device comprising possession, knowledge of secret data, and bio-metric authentication.

96. The method as recited in claim 42 further comprising correlating intermittently connected mobility devices intermittently connected with the host environment and/or mobility device management server with processes operable to park based on manual configuration.

97. The method as recited in claim 42 further comprising correlating intermittently connected mobility devices intermittently connected with a host environment and/or mobility device management server with one or more processes operable to park automatically based on parameters comprising an operating environment computational capacity (MIPS) and scalability, security of the operating environment, content licensing (rights management) capability, system management capabilities, operating environment stability (uptime), operating environment accessibility, network bandwidth and latency, and storage capacity.

98. The method as recited in claim 42 further comprising providing a secure time-service on the mobility device.

99. The method as recited in claim 42 further comprising providing a data-record time stamping and archival on the mobility device.

100. The method as recited in claim 42 further comprising providing a secondary communications interface on the mobility device comprising a USB and Ethernet communications interface.

101. The method as recited in claim 42 further comprising providing an X-windows proxy system for use on the host environment by the mobility device.

102. The method as recited in claim 42 further comprising providing one or more power interfaces on the mobility device comprising USB power interface, FireWire power interface, and powered Ethernet interface.

103. The method as recited in claim 42 further comprising engaging in RAM borrowing between the mobility device and the host environment.

104. The method as recited in claim 42 further comprising providing a bi-direction trust arbitration model for use by the mobility device and cooperating components.

105. The method as recited in claim 42 further comprising authenticating a participating user on the mobility device using a bio-metric fingerprint reader according to a selected sequence of fingerprints.

106. The method as recited in claim 42 further comprising providing one or more wireless data transceivers on the mobility device operable to allow the mobility device to operate on one or more cooperating wireless communications networks and/or municipal data communications grids comprising 802.XX, CDMA, GSM, BlueTooth, and WAP wireless communications networks and/or municipal data communication grids.

107. The method as recited in claim 106 further comprising selecting the one or more wireless data transceivers based on a selected function or operation being performed by the mobility device.

108. The method as recited in claim 107 further comprising selecting the one or more wireless data transceivers based on one or more use parameters comprising: cost, availability of the one or more cooperating wireless communications networks and/or municipal data communication grids, and preference of a participating user.
